(19) United States
(12) Patent Application Publication
(10) Pub. No.: US 2026/0307557 A1
(43) Pub. Date: Oct. 8, 2026

(54) ADJUSTING MECHANISM AND CHILD CARRIER

(71) Applicant: Wonderland Switzerland AG, Steinhausen (CH)

(72) Inventors: Xiangyong ZENG, Dongguan (CN); Ruyi LI, Dongguan (CN)

(73) Assignee: Wonderland Switzerland AG, Steinhausen (CH)

(21) Appl. No.: 19/483,400

(22) PCT Filed: May 13, 2024
(86) PCT No.: PCT/EP2024/063060

§ 371 Date: Nov. 11, 2025

(30) Foreign Application Priority Data
May 11, 2023 (CN) 202310535645.4
Nov. 2, 2023 (CN) 202311453080.1

(51) Int. Cl. B60N 2/28; A47D 13/02

(52) U.S. Cl. CPC B60N 2/2878; A47D 13/025; A47D 13/027; B60N 2/2845

(57) ABSTRACT

The present application relates to an adjusting mechanism and a child carrier. The adjusting mechanism is configured to adjust an angle between a seat part and a back rest part. The adjusting mechanism includes a locking member and a detent member . The locking member is mounted on one of the seat part and the back rest part. The locking member has a locking recess and a sliding recess thereon. The detent member is mounted on the other one of the seat part and the back rest part, and can move into the locking recess or the sliding recess . When the detent member is located in the locking recess the back rest part is fixed with respect to the seat part. When the detent member is located in the sliding recess the back rest part is pivotable relative to the seat part.

### CROSS-REFERENCE TO RELATED APPLICATIONS

The present application claims priority to Chinese patent application No. 2023105356454, filed on May 11, 2023; and Chinese patent application No. 2023114530801, filed on Nov. 2, 2023, the disclosure of which are incorporated herein by reference in their entireties.

### TECHNICAL FIELD

The present application relates to the field of child products, and in particular, an adjusting mechanism and a child carrier.

### BACKGROUND

A child carrier, such as infant car seat, safety seat, etc., generally include a seat part and a back rest part. In order to improve the comfort of the child when riding on the child carrier, the back rest part usually can pivot relative to the seat part, so that an angle between the back rest part and the seat part can be adjusted as required, and the child can be seated or lie flat inside the carrier. However, existing child carriers cannot adapt to different riding postures of children of different ages, such as a sitting posture, a reclining posture and a lie-flat posture. Therefore, the riding comfort of children is compromised, which is disadvantageous to the promotion of the child carriers. Although the angles between the back rest part and the seat part of some existing child carriers (for example, safety seats) are adjustable, the configurations of the angle adjusting mechanisms disposed in those child carriers are relatively complex, and the angle adjusting mechanisms are easy to get stuck during adjustment, resulting in inconvenient operation. The inconvenient operation leads to poor stability of the angle adjustment of the child carrier, and too many parts and components lead to excessive weight, affecting the user's experience.

### SUMMARY

According to various embodiments of the present application, an adjusting mechanism and a child carrier are provided.

An aspect of the present application provides an adjusting mechanism configured to adjust an angle between a seat part and a back rest part. The adjusting mechanism includes: a locking member configured to be mounted on one of the seat part and the back rest part, and having thereon a locking recess; a detent member movably disposed on the locking member; and a first operating member configured to be movably mounted on another of the seat part and the back rest part, and having a locked position and an unlocked position in its moving path. The first operating member is operatively connected to the detent member to drive the detent member to move on the locking member. When the first operating member is in the locked position, the detent member is located in the locking recess, and the back rest part is fixed with respect to the seat part. When the first operating member is in the unlocked position, the detent member is retracted from the locking recess, and the back rest part is pivotable with respect to the seat part.

In an embodiment, the locking recess is in communication with the sliding recess, and the detent member is continuously movable between the locking recess and the sliding recess.

In an embodiment, the locking recess includes a first locking groove and a second locking groove. When the detent member is located in the first locking groove, a first angle is formed between the seat part and the back rest part. When the detent member is located in the second locking groove, a second angle, which is different from the first angle, is formed between the seat part and the back rest part;

In an embodiment, a moving direction of the detent member is perpendicular to a transverse width direction of the seat part or the back rest part.

In an embodiment, the adjusting mechanism further includes a first operating member operatively connected to the detent member to drive the detent member to move with respect to the locking member. The first operating member is operable to move between a locked position and an unlocked position. when the first operating member is in the locked position, the detent member is located in the locking recess. When the first operating member is in the unlocked position, the detent member is located in the sliding recess.

In an embodiment, the adjusting mechanism further includes a sliding transmission member having a connecting part and a transmission part. The detent member is fixedly connected to the connecting part. The transmission part is drivingly connected to the first operating member. The first operating member is configured to drive the sliding transmission member and cause the detent member to move relative to the locking member when being operated, to switch the detent member between the locking recess and the sliding recess.

In an embodiment, a guide groove is formed on the transmission part. The guide groove extends in a direction intersecting with a moving direction of the first operating member. The first operating member has a drive part. The drive part is configured to be inserted in the guide groove and be movable along the guide groove.

In an embodiment, the drive part is disposed on an end of the first operating member, and an operation part, which is operable, is disposed on another end of the first operating member away from the drive part. The guide groove has a first groove end and a second groove end, which are oppositely disposed. The first groove end is closer to the locking member relative to the second groove end. The second groove end is closer to the operation part than the first groove end in a moving direction of the first operating member. When the first operating member is in the locked position, the drive part is located at the first groove end. When the first operating member is in the unlocked position, the drive part is located at the second groove end.

In an embodiment, the locking member is mounted on the seat part, and the first operating member is movably mounted on the back rest part. The adjusting mechanism further includes a mounting bracket configured to be fixedly mounted to the back rest part. A strip-shaped sliding groove is formed on the mounting bracket. The detent member extends through the strip-shaped sliding groove and the connecting part to be movably inserted into the locking member.

In an embodiment, the adjusting mechanism further includes a reset member abutting between the mounting bracket and the sliding transmission member. The reset member is configured to drive the sliding transmission member to reset, so that the detent member moves from the sliding recess to the locking recess.

In an embodiment, the locking recess further includes a transitional groove located between the first locking groove and the second locking groove and in communication with the sliding recess. When the detent member is located in the transitional groove, a third angle, which is different from the first angle and the second angle, is formed between the seat part and the back rest part.

Another aspect of the present application provides a child carrier, including a seat part, a back rest part and an adjusting mechanism as described in any one the foregoing embodiments. An end of the back rest part is pivotally connected to an end of the seat part, so that the child carrier has a first usage state and a second usage state. The adjusting mechanism is operatively disposed between the seat part and the back rest part, so that the child carrier can be switched between the first usage state and the second usage state.

In an embodiment, one of the seat part and the back rest part is provided with a first pivot fitting part, and another of the seat part and the back rest part is provided with a second pivot fitting part. The seat part and the back rest part are pivotally connected through the first pivot fitting part and the second pivot fitting part.

In an embodiment, the child carrier further includes a fitting connection member. The fitting connection member pivotally connects the first pivot fitting part to the second pivot fitting part.

In an embodiment, the first pivot fitting part includes a pivot member, and the second pivot fitting part includes a pivot base. A first engagement groove is formed on the pivot base. The fitting connection member includes a pivot cover. A second engagement groove is formed on the pivot cover. The first engagement groove and the second engagement groove enclose a pivot groove. At least a part of the pivot member is inserted in the pivot groove, and rotatable in the pivot groove to switch the child carrier between the first usage state and the second usage state.

In an embodiment, the locking recess includes a first locking groove and a second locking groove. When the detent member is located in the first locking groove, the child carrier is in the first usage state. When the detent member is located in the second locking groove, the child carrier is in the second usage state. When the detent member is located in the sliding recess, the back rest part is pivotable relative to the seat part, to switch the child carrier between the first usage state and the second usage state.

In an embodiment, when the child carrier is in the first usage state, a child is in a lie-flat state in the child carrier. When the child carrier is in the second usage state, a child is in a sitting state in the child carrier.

In an embodiment, the locking recess further includes a transitional groove located between the first locking groove and the second locking groove and in communication with the sliding recess. When the detent member is located in the transitional groove, the child carrier is in a transition state between the first usage state and the second usage state.

Another aspect of the present application provides a child carrier, including a seat part and a back rest part that is pivotable relative to each other. One of the seat part and the back rest part is provided with a first pivot fitting part, and another of the seat part and the back rest part is provided with a second pivot fitting part. The seat part and the back rest part are pivotally connected through the first pivot fitting part and the second pivot fitting part.

In an embodiment, the child carrier further includes a fitting connection member. The fitting connection member pivotally connects the first pivot fitting part to the second pivot fitting part.

In an embodiment, the first pivot fitting part includes a pivot member, and the second pivot fitting part includes a pivot base. A first engagement groove is formed on the pivot base. The fitting connection member includes a pivot cover. A second engagement groove is formed on the pivot cover. The first engagement groove and the second engagement groove enclose a pivot groove. At least a part of the pivot member is inserted in the pivot groove, and rotatable in the pivot groove to switch the child carrier between the first usage state and the second usage state.

In an embodiment, the first engagement groove and the second engagement groove are both arc-shaped. The pivot member has an arc-shaped surface whose radian matches that of a groove wall of the pivot groove.

In an embodiment, a first connecting hole is formed on the pivot base, and a second connecting hole is formed on the pivot cover. The fastener extends through the first connecting hole and the second connecting hole to fixedly connect the pivot base to the pivot cover.

Yet another aspect of the present application further provides an adjusting device for a child carrier. The child carrier includes a housing and a back rest part. The back rest part is pivotally connected to the housing to form a riding space for carrying a child. The back rest part has a first angular position and a second angular position relative to the housing. The adjusting device includes: a locking mechanism disposed between the housing and the back rest part, wherein the locking mechanism has a locked state in which the back rest part is fixed in the first angular position or the second angular position, and an unlocked state in which the back rest part is allowed to switch between the first angular position and the second angular position; and an operating mechanism drivingly connected to the locking mechanism. The operating mechanism is operable to drive the locking mechanism to switch from the locked state to the unlocked state.

In an embodiment, the locking mechanism is movably disposed on the back rest part, and includes a locking part and a first sliding cooperative part. The operating mechanism includes: a second operating member; and a linkage member connected to the second operating member and having a second sliding cooperative part. A third engaging groove and a fourth engaging groove are formed on the housing. When the locking mechanism is in the locked state, the locking part is engaged with the third engaging groove or the fourth engaging groove. When the locking mechanism is in the unlocked state, the locking part is disengaged from the third engaging groove or the fourth engaging groove. When the second operating member is operated, the linkage member is driven to move, and the second sliding cooperative part on the linkage member cooperates with the first sliding cooperative part on the locking mechanism, so that the locking part is disengaged from the third engaging groove or the fourth engaging groove.

In an embodiment, the locking mechanism further includes: an actuator having the first sliding cooperative part arranged thereon; and a locking pin connected to the actuator, at least a part of the locking pin forming the locking part.

In an embodiment, the actuator includes: an actuator body; and a positioning protrusion protruding from the actuator body and forming the first sliding cooperative part. The second sliding cooperative part is a sliding groove formed on the linkage member, and the positioning protrusion is inserted in the sliding groove and is movable along the sliding groove.

In an embodiment, a mounting hole is formed on the actuator body. An extending direction of the mounting hole intersects with an extending direction of the positioning protrusion. The locking pin is inserted in the mounting hole.

In an embodiment, a mounting groove, which is in communication with the mounting hole, is formed on the actuator body. An elastic finger is disposed on a side groove wall of the mounting groove. The elastic finger cooperates with the locking pin to fix the locking pin in the mounting hole.

In an embodiment, one of the elastic finger and the locking pin has a convex portion, and another of the elastic finger and the locking pin has a recess portion capable of cooperating with the convex portion.

In an embodiment, the operating mechanism further includes an operating reset member. A first end of the operating reset member is connected to or abuts against the linkage member. A second end of the operating reset member is connected to or abuts against a stop member on the back rest part. The operating reset member is adapted to cause the linkage member to drive the second operating member to reset.

In an embodiment, the linkage member includes a mounting frame movably disposed on the back rest part. A receiving space is formed in the mounting frame. The operating reset member and the stop member are both received in the receiving space.

In an embodiment, a mounting base is disposed on a side of the mounting frame adjacent to the locking mechanism. The first end of the operating reset member is fixed to the mounting base.

In an embodiment, the operating reset member is a spring. The mounting frame or the stop member is provided with a guide member. The spring is sleeved on the guide member.

In an embodiment, the mounting frame includes a first side part and a second side part, which are oppositely disposed. A stopper is connected between the first side part and the second side part. The stopper is configured to prevent the operating reset member from being escaped from the receiving space.

In an embodiment, the operating mechanism further includes a pulling member. Two ends of the pulling member are respectively connected to the second operating member and the mounting frame.

Yet another aspect of the present application provides a child carrier. The child carrier includes a back rest part, a housing and the adjusting device according to any one of the above embodiments. The back rest part and the housing are pivotally connected at a fixed first pivot point. The first pivot point is located in front of a handle coupling part disposed on the housing.

In an embodiment, the first pivot point is located at a lower front side of the handle coupling part.

In an embodiment, a mounting part is disposed on a side surface of the housing. The mounting part is disposed behind the handle coupling part and at an upper edge of a surface of the housing facing the riding space. A third engaging groove and a fourth engaging groove, which cooperate with the locking mechanism, are formed on the mounting part to switch the locking mechanism between the locked state and the unlocked state.

In an embodiment, the locking mechanism includes a locking part cooperating with the third engaging groove and the fourth engaging groove. The locking part can be engaged with the third engaging groove and the fourth engaging groove to fix the back rest part in the first angular position or the second angular position. Extending directions of the third engaging groove and the fourth engaging groove intersect with a front-rear direction of the child carrier.

In an embodiment, the mounting part protrudes toward the riding space. An avoiding recess corresponding to the mounting part is formed on the back rest part, to allow the back rest part to pivot relative to the housing.

In an embodiment, the child carrier further includes a mounting plate. The mounting plate is fixed to a side of the housing facing the riding space. A limiting rib is disposed on the mounting plate. A stop surface is formed at a lower edge of the back rest part. The stop surface is configured to cooperate with the limiting rib to limit a pivot angle of the back rest part relative to the housing.

In an embodiment, a limiting protrusion or a limiting groove is formed at a rear part of a side surface of the housing. A limiting groove or limiting protrusion matching the limiting protrusion or the limiting groove is formed at a position of the back rest part corresponding to the limiting protrusion or the limiting groove. The limiting protrusion is inserted in the limiting groove. When the back rest part pivots relative to the housing, the limiting protrusion slides in the limiting groove.

In an embodiment, the back rest part includes a back rest extension. The back rest extension overlaps with at least a part of the housing. A sliding hole is formed on the back rest extension. A connecting hole is formed on the part of the housing overlapping with the back rest extension. The sliding hole and the connecting hole at least partially overlap. One of the sliding hole and the connecting hole is strip-shaped. A sliding pin extends through the sliding hole and the connecting hole to guide the back rest part to move in the front-rear direction relative to the housing.

In an embodiment, the child carrier further includes a leg rest part. The leg rest part is fixedly connected to the housing; or the leg rest part and the housing are integrally formed.

Yet another aspect of the present application provides a child carrier. The child carrier includes a back rest part, a leg rest part, a housing and the adjusting device according to any one of the above embodiments. The back rest part and the leg rest part are pivotally connected at a movable third pivot point. The third pivot point is located in front of a handle coupling part disposed on the housing.

In an embodiment, the third pivot point is located at a lower front side of the handle coupling part.

In an embodiment, a mounting part is disposed on a side surface of the housing. The mounting part is disposed behind the handle coupling part and at an upper edge of a surface of the housing facing the riding space. A third engaging groove and a fourth engaging groove, which cooperate with the locking mechanism, are formed on the mounting part to switch the locking mechanism between the locked state and the unlocked state.

In an embodiment, a fitting hole is formed on the housing in a height direction. A pivot pin is disposed at the third pivot point between the back rest part and the leg rest part. The pivot pin is insertable into the fitting hole and is movable along the fitting hole.

In an embodiment, a rotation pin is disposed at one of a rear side of the leg rest part and a front side of the housing, and a rotation hole is disposed at another of the rear side of the leg rest part and the front side of the housing. The leg rest part and the housing are pivotally connected at the second pivot point by the rotation pin being inserted into the rotation hole.

### BRIEF DESCRIPTION OF THE DRAWINGS

The drawings, which form part of the present application, are used to provide a further understanding of the present application. The illustrative embodiments of the present application and their descriptions are used to illustrate the present application, and do not constitute any improper limitation of the present application.

In order to describe the technical solution in the embodiments of the present application more clearly, the drawings required for the description of the embodiments are briefly described below. Obviously, the drawings in the following description merely illustrate some embodiments of the present application. For those of ordinary skill in the art, other drawings may be obtained according to these drawings without involving any creative efforts.

In addition, the drawings are not necessarily drawn to a 1:1 scale, and the sizes of the individual elements are only illustratively drawn in the drawings, not necessarily to the true scale, wherein:

FIG. 1 is a perspective view of a child carrier according to an embodiment of the present application, where the child carrier is in a lie-flat state;

FIG. 2 is another perspective view of the child carrier of FIG. 1;

FIG. 3 is a side view of the child carrier of FIG. 1;

FIG. 4 is a perspective view of a child carrier according to an embodiment of the present application, in which the child carrier is in a seating state;

FIG. 5 is a side view of the child carrier of FIG. 4;

FIG. 6 is a cross-sectional view taken along a line U1-U1 in FIG. 4;

FIG. 7 is a cross-sectional view taken along a line U2-U2 in FIG. 4;

FIG. 8 is schematic view illustrating a partial structure of a back rest part of the child carrier shown in FIG. 1;

FIG. 9 is a perspective view of a pivot cover of the child carrier shown in FIG. 1;

FIG. 10 is schematic view illustrating a partial structure of a seat part of the child carrier shown in FIG. 1;

FIG. 11 is still another perspective view of a child carrier in an embodiment of the present application, in which a handle is omitted, and a mounting bracket is omitted in the illustrated adjusting mechanism;

FIG. 12 is a cross-sectional view taken along a line U3-U3 in FIG. 11, in which the mounting bracket is illustrated;

FIG. 13 is a cross-sectional view taken along a line U4-U4 in FIG. 11, in which a first operating member is in a locked position;

FIG. 14 is a cross-sectional view taken along a line U4-U4 in FIG. 11, in which a first operating member is in an unlocked position;

FIG. 15 is a perspective view of a locking member of the child carrier shown in FIG. 11;

FIG. 16 is a perspective view of a first operating member of the child carrier shown in FIG. 11;

FIG. 17 is a perspective view of a sliding transmission member of the child carrier shown in FIG. 11;

FIG. 18 is a perspective view of the mounting bracket of the child carrier shown in FIG. 11;

FIG. 19 is a schematic view of a child carrier according to a second embodiment of the present application, in which the child carrier is in a state suitable for a sitting posture of a child;

FIG. 20 is a schematic view of the child carrier according to the second embodiment of the present application, in which the child carrier is in a state suitable for a reclining posture of a child;

FIG. 21 is a schematic view of the child carrier according to the second embodiment of the present application, in which the child carrier is in a state suitable for a lie-flat posture of a child;

FIG. 22 is a cross-sectional view of the child carrier shown in FIG. 19 in its front-rear direction;

FIG. 23 is a cross-sectional view of the child carrier shown in FIG. 20 in its front-rear direction;

FIG. 24 is a cross-sectional view of the child carrier shown in FIG. 21 in its front-rear direction;

FIG. 25 is a schematic perspective view of the child carrier shown in FIG. 19;

FIG. 26 is a schematic perspective view of the child carrier shown in FIG. 21;

FIG. 27 is a schematic view of a back rest part of the child carrier shown in FIG. 19;

FIG. 28 is a schematic view of a housing of the child carrier shown in FIG. 19;

FIG. 29 is another schematic perspective view of the child carrier shown in FIG. 19;

FIG. 30 is an enlarged view of a portion A shown in FIG. 29;

FIG. 31 is still another schematic perspective view of the child carrier shown in FIG. 19;

FIG. 32 is an enlarged view of a portion B shown in FIG. 31;

FIG. 33 is a schematic view of the back rest part shown in FIG. 27, in which a cover body is omitted;

FIG. 34 is an enlarged view of a portion C shown in FIG. 33;

FIG. 35 is a schematic view of an actuator shown in FIG. 34;

FIG. 36 is a schematic view of a child carrier in an example of the present application;

FIG. 37 is a schematic view of a back rest part of the child carrier shown in FIG. 36;

FIG. 38 is a schematic view of a mounting plate of the child carrier shown in FIG. 36;

FIG. 39 is a schematic view of a child carrier according to a third embodiment of the present application, in which the child carrier is in a state suitable for a sitting posture of a child;

FIG. 40 is a schematic view of the child carrier according to the third embodiment of the present application, in which the child carrier is in a state suitable for a lie-flat posture of a child;

FIG. 41 is a schematic view of a child carrier according to a fourth embodiment of the present application, in which the child carrier is in a state suitable for a sitting posture of a child; and

FIG. 42 is a schematic view of the child carrier according to the fourth embodiment of the present application, in which the child carrier is in a state suitable for a lie-flat posture of a child.

### ILLUSTRATION OF REFERENCE NUMERALS

1000, child carrier;
100, seat part; 101, first pivot point; 102, handle coupling part; 103, second pivot point; 104, third pivot point; 110, housing; 111, connecting hole; 112, housing body; 113, housing side plate; 120, bracket; 121, bracket body; 1210, pivot protrusion; 122, bracket bottom wall; 1220, fitting hole; 123, bracket side wall; 130, through hole; 1300, limiting groove; 131, first end; 132, second end; 140, moving slot; 150, leg rest part;
200, back rest part; 201, operation hole; 210, back rest body; 220, back rest side plate; 221, pivot hole; 222, stop surface; 223, pivot pin; 230, back rest extension; 231, sliding hole; 240, stop member; 241, guide member; 250, avoiding recess; 260, limiting protrusion; 270, moving protrusion; 280, head rest part;
300, riding space;
400, pivot structure; 410, pivot groove; 420, pivot member; 421, arc-shaped surface; 430, pivot base; 431, first engagement groove; 432, first connecting hole; 433, joining part, 440, pivot cover; 441, second engagement groove; 442, second connecting hole;
500, adjusting mechanism; 510, locking member; 511, locking recess; 5111, locking groove; 5111A, first locking groove; 5111B, second locking groove; 5111C, transitional groove; 512, sliding recess; 520, detent member; 530, first operating member; 531, drive part; 5311, latch; 5312, pull block; 5313, first clamping chamber; 532, operation part; 540, sliding transmission member; 541, connecting part; 542, transmission part; 543, guide groove; 5431, first groove end; 5432, second groove end; 544, second clamping chamber; 5441, perforation; 545, third clamping chamber; 546, limiting boss; 550, mounting bracket; 551, strip-shaped sliding groove; 560, reset member; 570, latching member;
600, adjusting device; 610, locking mechanism; 611, actuator; 6111, actuator body; 6111a, first side surface; 6111b, second side surface; 6111c, third side surface; 6111d, mounting hole; 6111e, mounting groove; 6111f, elastic finger; 6112, positioning protrusion; 612, locking pin; 6122, locking part;
620, operating mechanism; 621, second operating member; 622, pulling member; 623, linkage member; 6231, mounting frame; 6231a, receiving space; 6231b, mounting base; 6231c, stopper; 6231d, first side part; 6231e, second side part; 6232, linkage part; 6233, sliding groove; 624, operating reset member;
700, mounting plate; 710, mounting part; 711, engaging groove; 720, limiting rib; 7000, handle; and
800, engaging member.

### DETAILED DESCRIPTION

In order to better understand the above objects, features, and advantages of the present application, a detailed description of the specific embodiments of the present application will be provided below in combination with the drawings. Many specific details are set forth in the following description to facilitate a thorough understanding of this application. However, the present application can be implemented in many ways other than those described herein, and those skilled in the art can make similar improvements without departing from the spirit of the present application. Therefore, the present application is not limited by the specific embodiments disclosed below.

Embodiments of the present application provides a child carrier 1000, which may be, for example, an infant car seat or a child seat. Specifically, in the present application, child carrier 1000 is described in the following taking an infant car seat as an example.

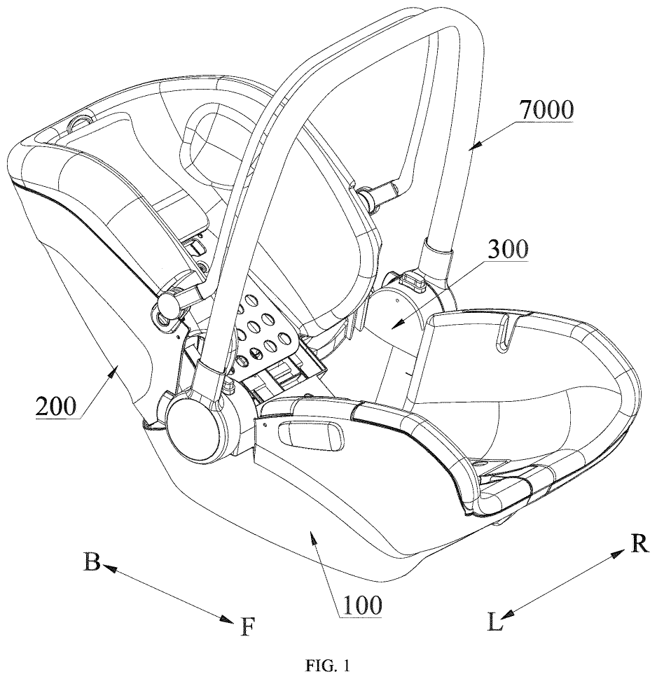

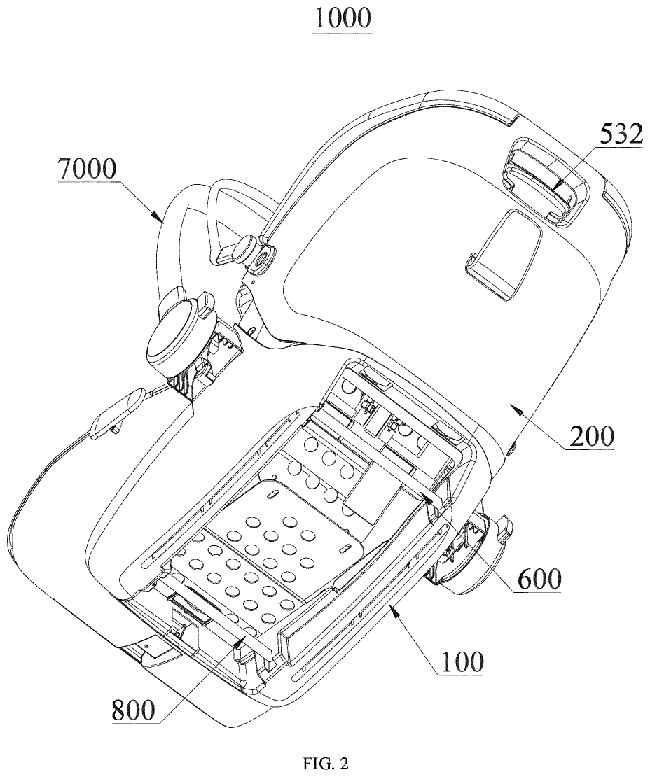

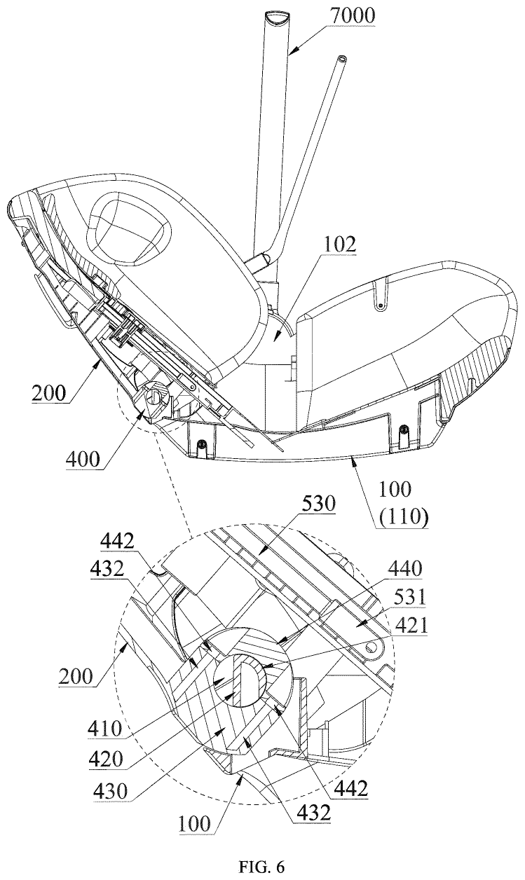

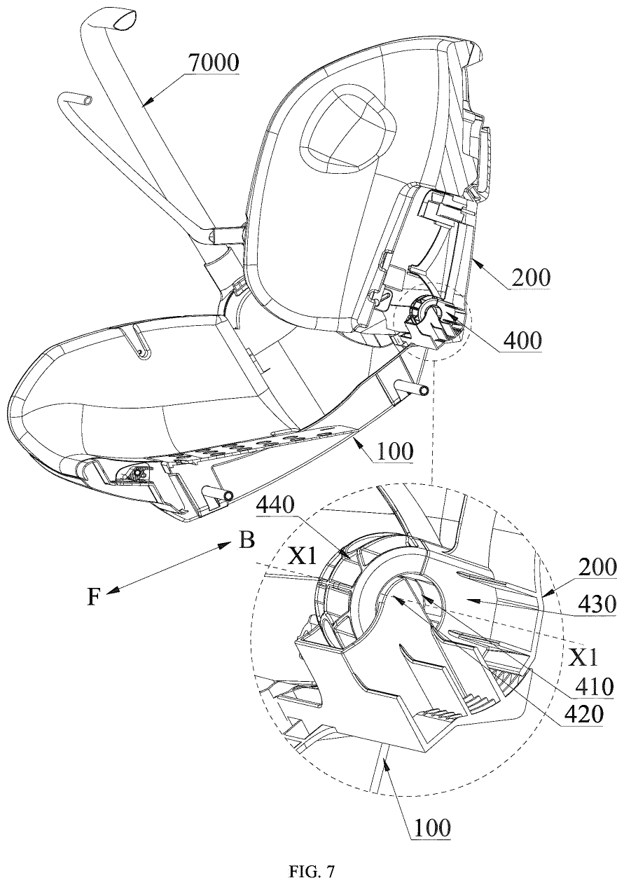

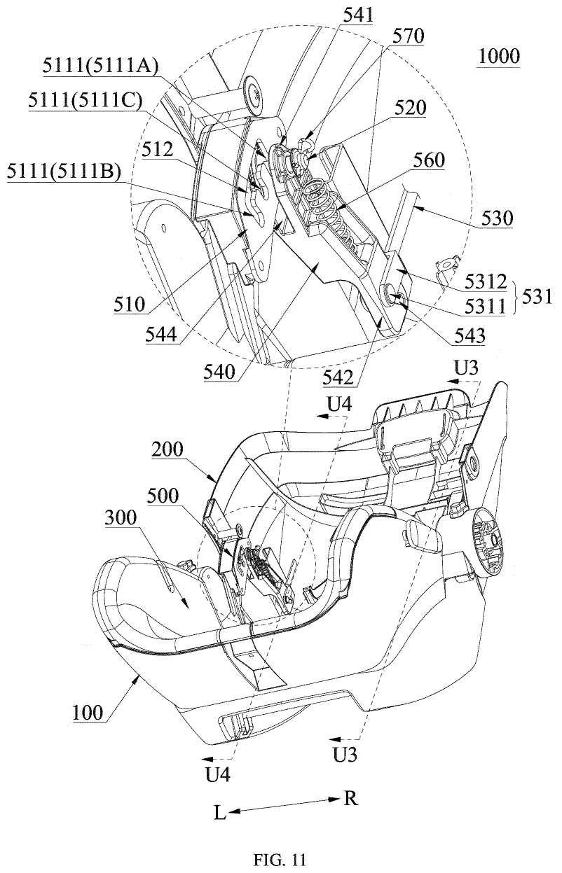

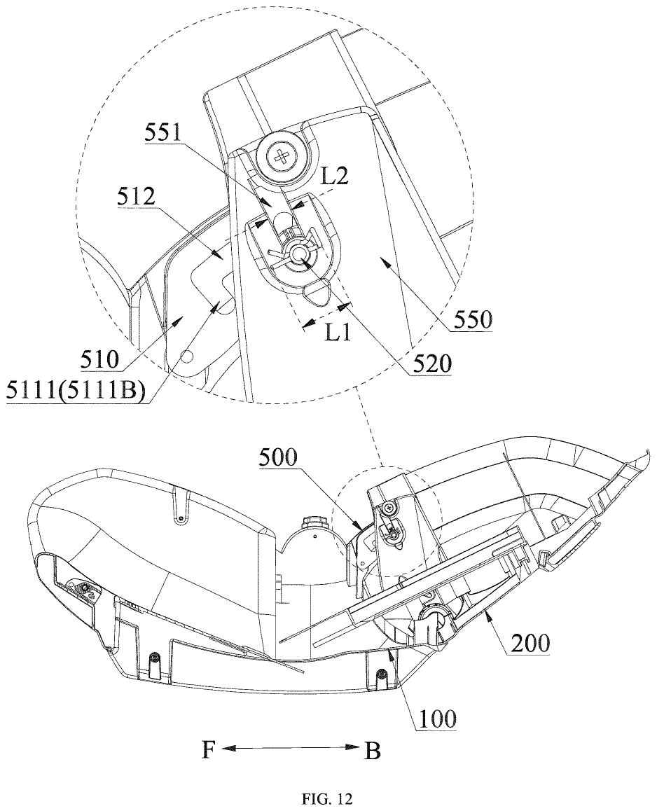

FIGS. 1 and 2 schematically show perspective views of the child carrier 1000 (which is shown as an infant car seat) according to a first embodiment of the present application. The infant car seat includes a seat part 100, a back rest part 200, a pivot structure 400 (see FIGS. 6 and 7) and an adjusting mechanism 500 (see FIGS. 11 and 12).

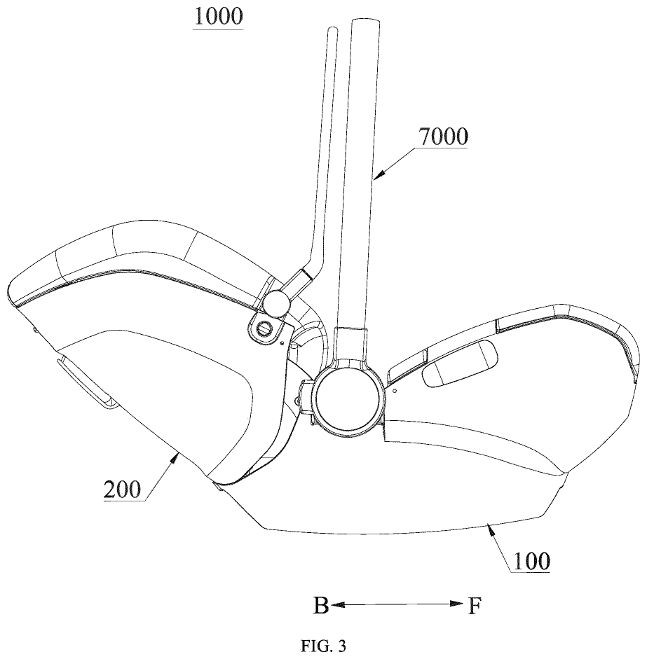

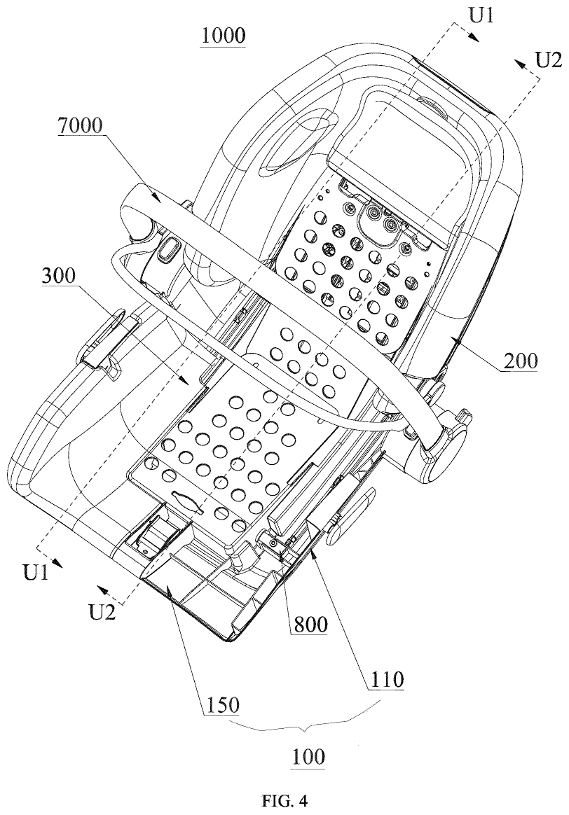

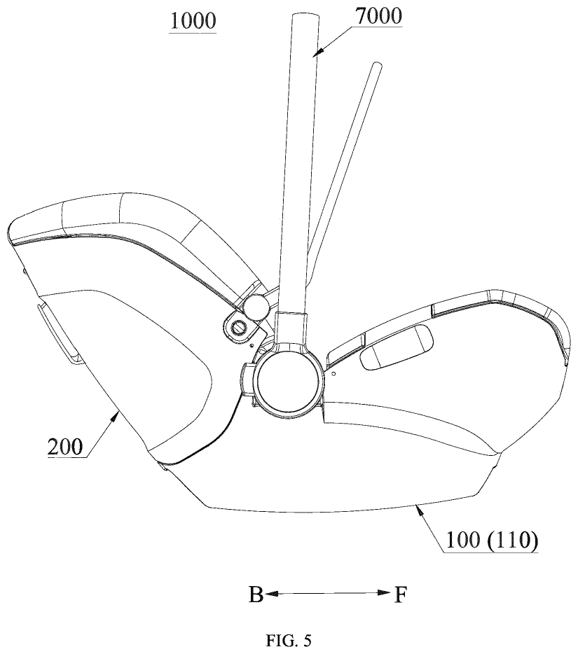

Referring to FIGS. 1 to 3, in some examples, the back rest part 200 is arranged at an angle with respect to the seat part 100 to form a riding space 300. In an embodiment, the back rest part 200 is configured to support an upper body (e.g., the head and back) of a child. The seat part 100 is configured to support a lower body (e.g., buttocks and legs) of the child. The seat part 100 may include a housing 110 and a leg rest part 150. The back rest part 200 is pivotally connected to the housing 110 to form the riding space 300 for carrying a child. In the first embodiment, the leg rest part 150 and the housing 110 are integrally formed. In other embodiments, the leg rest part 150 and the housing 110 may also be fixedly connected to each other by bolting, riveting, welding or the like. The back rest part 200 has at least two angular positions with respect to the housing 110 to meet different riding needs of children, such as needs for sitting and lying postures at different angles. For example, a first usage state of the back rest part 200 with respect to the housing 110 in FIGS. 1 and 3 is suitable for a case where the child lies flat. A second usage state of the back rest part 200 with respect to the housing 110 in FIGS. 4 and 5 is suitable for a case where the child is seated. It should be understood that the back rest part 200 may have more than two or less than two angular positions with respect to the housing 110 according to actual needs, which is not limited in the present application. In addition, it should be understood that a correspondence relationship between the first usage state and the second usage state of the back rest part 200 with respect to the housing 110, and the postures of the child on the child carrier 1000 is merely exemplary, the first usage state and the second usage state of the back rest part 200 with respect to the housing 110 does not necessarily correspond to the lie-flat state of the child and the sitting state of the child respectively. For example, the first usage state may be suitable for the sitting state of the child, the second usage state may be suitable for the lie-flat state of the child, and the like, which is not limited in the present application.

In some embodiments, when the back rest part 200 of the child carrier 1000 is adjusted with respect to the housing 110 to be suitable for the lie-flat posture of the child, an angle between the back rest part and the horizontal direction is larger than an angle between the leg rest part and the horizontal direction, so that the legs of the child is not higher in level than the position of the head when the child lies flat, and the lie-flat comfort of the child is improved.

The seat part 100 is provided with an engaging member 800 on a side facing away from the riding space 300. The engaging member 800 is mainly configured to be engaged with a carrier base on a vehicle seat, so that child carrier 1000 (such as the infant car seat) can be stably fixed on the vehicle seat. Specifically, the engaging member 800 has a rod-shaped structure, which is fixedly connected to a bottom of the seat part 100 by a fastener (such as a screw, a bolt, or the like) or directly integrally formed on the bottom of the seat part 100.

In order to facilitate carrying of the child carrier by the user, in some examples, as shown in FIGS. 1 and 3, the child carrier 1000 (such as the infant car seat) further includes a handle 7000. The handle 7000 is connected to the seat part 100 or the back rest part 200. Optionally, the handle 7000 is removably or non-removably mounted to the seat part 100 or the back rest part 200. In the first embodiment, the housing 110 is provided with a handle coupling part 102 (see FIG. 6). The handle 7000 is removably and pivotally connected to the handle coupling part 102 on the seat part 100. In this way, when it is required to carry the child carrier 1000, the handle 7000 is pivoted away from the seat part 100 or the back rest part 200, so as to be held by the user; and when it is not required to carry the child carrier 1000, the handle 7000 is pivoted to be close to the seat part 100 or the back rest part 200, so as to prevent the handle 7000 from blocking a field of vision of the child, and at the same time, it is convenient for the user to put the child into the infant car seat or take the child out of the child carrier.

In the first embodiment, the seat part 100 may be pivotally connected with the back rest part 200. In other embodiments, the seat part 100 and the back rest part 200 may be fixedly connected, that is, the seat part 100 and the back rest part 200 may not move relative to each other. Specifically, in the first embodiment, an end of the seat part 100 is pivotally connected to an end of the back rest part 200, that is, an angle between the seat part 100 and the back rest part 200 can be adjusted, so that the child carrier 1000 can have at least two usage states. The at least two usage states may include, for example, the first usage state shown in FIGS. 1 and 3 (in which the child is in the lie-flat state in the child carrier) or the second usage state shown in FIGS. 4 and 5 (in which the child is in the sitting state in the child carrier). In another example, at least one transition state may be arranged between the first usage state and the second usage state. In this way, the user can adaptively adjust the angle between the seat part 100 and the back rest part 200 according to the state of the child (for example, a sleep state and an awake state), thereby improving the comfort of the child in the child carrier.

Referring to FIGS. 4 to 7, in some examples, the back rest part 200 and the seat part 100 are pivotally connected through the pivot structure 400. Specifically, a front end of the back rest part 200 is pivotally connected to a rear end of the seat part 100 through the pivot structure 400. More specifically, the pivot structure 400 includes a first pivot fitting part, a second pivot fitting part, and a fitting connection member. The first pivot fitting part is provided on one of the seat part 100 and the back rest part 200, and the second pivot fitting part is provided on another of the seat part 100 and the back rest part 200. The seat part 100 and the back rest part 200 are pivotally connected through the first pivot fitting part and the second pivot fitting part. The fitting connection member pivotally connects the first pivot fitting part to the second pivot fitting part.

Specifically, the first pivot fitting part includes a pivot member 420, and the second pivot fitting part includes a pivot base 430. A first engagement groove 431 is formed on the pivot base 430. The fitting connection member includes a pivot cover 440. A second engagement groove 441 is formed on the pivot cover 440. The first engagement groove 431 and the second engagement groove 441 enclose a pivot groove 410. At least a part of the pivot member 420 is inserted in the pivot groove 410 and rotatable in the pivot groove 410, so that the child carrier 1000 can be switched between the first usage state and the second usage state. In the first embodiment, as shown in FIGS. 6 and 7, the pivot base 430 is provided on the back rest part 200, and the pivot member 420 is provided on the seat part 100.

It should be noted that the “front end” used herein refers to an end of the seat part 100 away from the back rest part 200, and the “rear end” refers to an end of the back rest part 200 away from the seat part 100. More specifically, the “front end” refers to an end of the child carrier adjacent to the foot of the child, and the “rear end” refers to an end adjacent to the head of the child. In addition, unless otherwise expressly specified and defined, orientations such as “front,” “rear,” “left,” and “right” of the child carrier 1000 (for example, the infant car seat) in various embodiments of the present application may be respectively denoted by arrows F, B, L and R in the figures. These orientational terms are only used to make the description of the embodiments of the present application clearer, and are not used to unduly limit the protection scope of the present application.

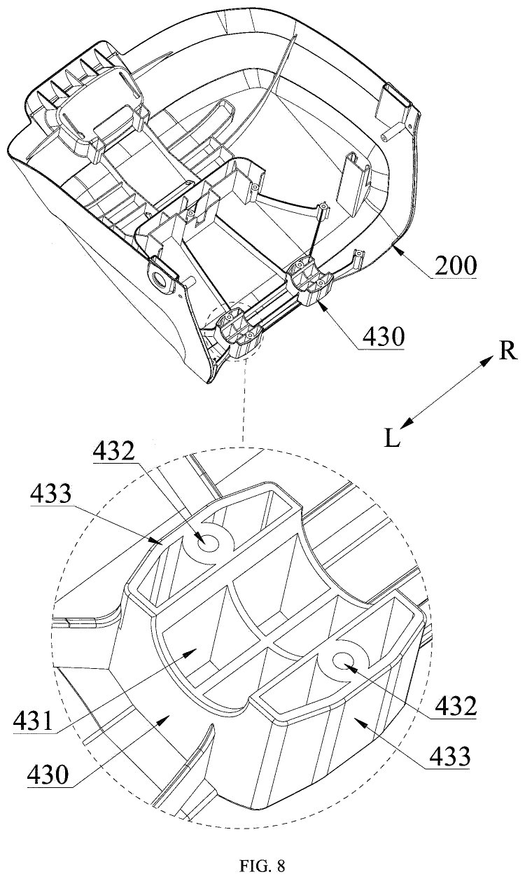

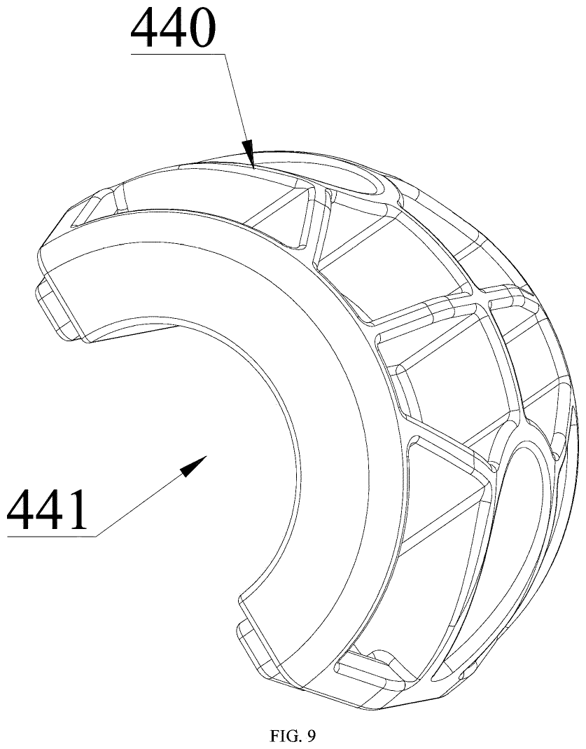

Referring to FIGS. 6 to 10, specifically, the pivot cover 440 is removably mounted on the pivot base 430. For example, the pivot cover 440 is mounted on the pivot base 430 by means of a snap fit. Alternatively, the pivot cover 440 is mounted on the pivot base 430 by means of a screw connection. Specifically, in the first embodiment, as shown in FIGS. 6 and 8, a first connecting hole 432 is formed on the pivot base 430, and a second connecting hole 442 is formed on the pivot cover 440. Fasteners such as connecting screws or connecting bolts extend through the second connecting hole 442 and the first connecting hole 432 sequentially to connect the pivot cover 440 to the pivot base 430.

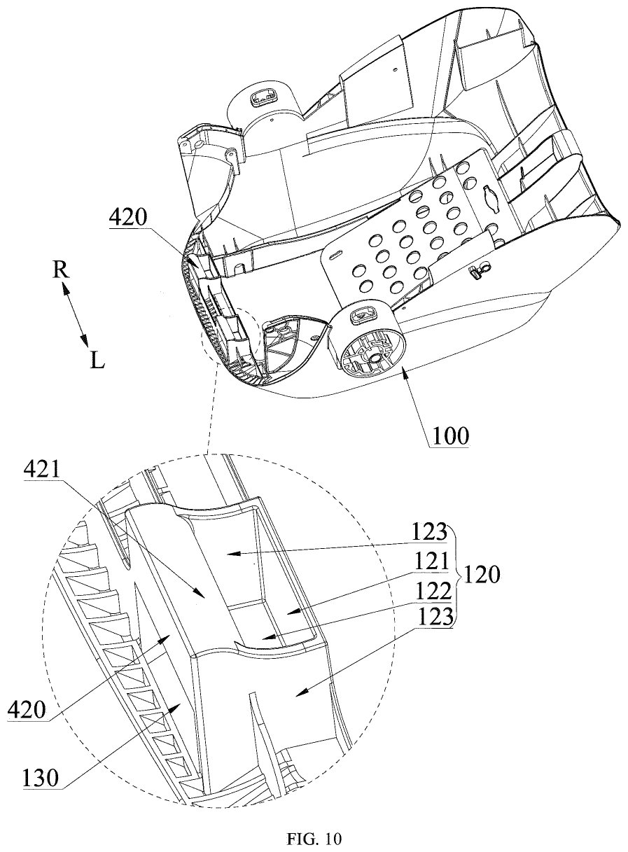

Referring to FIGS. 6 to 9, in some examples, the first engagement groove 431 and the second engagement groove 441 are both arc-shaped. As shown in FIGS. 6 and 10, the pivot member 420 has an arc-shaped surface 421 whose radian matches that of a groove wall of the pivot groove 410. As such, the smoothness of rotation of the pivot member 420 in the pivot groove 410 can be improved. Specifically, in the first embodiment, both the first engagement groove 431 and the second engagement groove 441 are semi-circular, so that the first engagement groove 431 and the second engagement groove 44 can enclose the circular pivot groove 410. In other alternative embodiments, the first engagement groove 431 and the second engagement groove 441 may have other shapes, as long as the first engagement groove 431 and the second engagement groove 441 can enclose a complete circular pivot groove 410. For example, when the first engagement groove 431 is a ⅔ arc-shaped groove, the second engagement groove 441 is a ⅓ arc-shaped groove.

In some examples, one of the pivot base 430 and the pivot member 420 is integrally formed on the seat part 100, and another of the pivot base 430 and the pivot member 420 is integrally formed on the back rest part 200. In other words, when the pivot base 430 is integrally formed on the seat part 100, the pivot member 420 is integrally formed on the back rest part 200. When the pivot base 430 is integrally formed on the back rest part 200, the pivot member 420 is integrally formed on the seat part 100. Specifically, as described above, in the first embodiment, as shown in FIGS. 8 and 10, the pivot base 430 is integrally formed on the back rest part 200, and the pivot member 420 is integrally formed on the seat part 100. In this way, the structural strength of the pivot structure 400 is improved, thereby improving the reliability of the pivoting. In other alternative embodiments, one of the pivot base 430 and the pivot member 420 is removably connected to the seat part 100, and another of the pivot base 430 and the pivot member 420 is removably connected to the back rest part 200. By integrally forming the pivot structure 400 with the seat part 100 and the back rest part 200, the pivoting connection between the back rest and the seat is realized, which eliminates the needs for providing separate pivot shafts and pivot holes, so that the number of components and parts is reduced, the lie-flat function is simplified, the adjustment is more stable and reliable, and the overall child carrier is lighter.

In the first embodiment, the pivot base 430 is located at an end of the back rest part 200 adjacent to the seat part 100, that is, at the front end of the back rest part 200. The pivot member 420 is located at an end of the seat part 100 adjacent to the back rest part 200, that is, at the rear end of the seat part 100.

Specifically, the pivot base 430 includes joining parts 433 respectively formed on both sides of the first engagement groove 431. Two first connecting holes 432 as described above are provided, and are respectively disposed on the two joining parts 433. In the first embodiment, a bracket 120 is formed on the seat part 100. The bracket 120 includes a bracket body 121, a bracket bottom wall 122, and two bracket sidewalls 123. The bracket body 121 is connected to the bracket bottom wall 122 at an angle. The two bracket sidewalls 123, which are arranged opposite to each other, are both connected to the bracket body 121, and are connected to the two sides of the bracket bottom wall 122 respectively. The pivot member 420 is connected between the two bracket sidewalls 123. A through hole 130 is defined among the pivot member 420, the bracket body 121, the bracket bottom wall 122, and the two bracket sidewalls 123. The joining part 433 is adapted to be received in the through hole 130 to connect the back rest part 200 to the seat part 100.

Referring to FIGS. 8 and 10, in the first embodiment, the child carrier is provided with two pivot structures 400 as described above. The two pivot structures 400 are spaced apart from each other in a left-right direction of the child carrier. In this way, the stability of the pivoting of the back rest part 200 with respect to the seat part 100 can be improved. In other embodiments, one or more pivot structure 400 may be provided as required, and which is not limited thereto.

Referring to FIGS. 11 to 14, the adjusting mechanism 500 is disposed between the seat part 100 and the back rest part 200, to adjust the angle between the seat part 100 and the back rest part 200 and to keep the angle between the seat part 100 and the back rest part 200 unchanged. Specifically, the adjusting mechanism 500 includes a locking member 510, a detent member 520, and a first operating member 530. The locking member 510 is mounted on one of the seat part 100 and the back rest part 200. A locking recess 511 is disposed on the locking member 510. In the first embodiment, the detent member 520 is a locking pin member. The detent member 520 is mounted on another of the seat part 100 and the back rest part 200. The detent member 520 can be engaged with and disengaged from the locking recess 511, to lock the back rest part 200 with respect to the seat part 100, and unlock the back rest part 200 from the seat part 100. In the first embodiment, a moving direction of the detent member 520 is perpendicular to a transverse width direction of the seat part 100 or the back rest part 200. The detent member 520 moves in the direction perpendicular to the transverse width direction of the seat part 100 or the back rest part 200 to lock the seat part 100 with respect to the back rest part 200 and unlock the seat part 100 from the back rest part 200, so that the moving stroke and path of the detent member 520 can be arranged more flexibly. Specifically, since the locking member 510 has a sheet-like structure and a plane in which the locking member 510 is located is perpendicular to the transverse width direction of the seat part 100 or the back rest part 200, and both the locking recess 511 and a sliding recess 512 are formed on the sheet-like locking member, a plane in which the locking recess 511 and the sliding recess 512 are located is also perpendicular to the transverse width direction of the seat part 100 or the back rest part 200.

The first operating member 530 is movably mounted on the other of the seat part 100 and the back rest part 200, and has a locked position and an unlocked position in its moving path. The first operating member 530 is operatively connected to the detent member 520 to drive the detent member 520 to move on the locking member 510. Specifically, when the first operating member 530 is in the locked position, the detent member 520 is located in the locking recess 511, and the back rest part 200 is fixed with respect to the seat part 100, that is, the back rest part 200 cannot pivot with respect to the seat part 100, so that the child carrier can be kept in a specific usage state, such as the first usage state or the second usage state. When the first operating member 530 is in the unlocked position, the detent member 520 is retracted from the locking recess 511, and the back rest part 200 is pivotable with respect to the seat part 100, that is, the angle between the back rest part 200 and the seat part 100 can be adjusted. In addition, the strength of the adjusting mechanism 500 can be effectively enhanced by disposing the locking member 510 on the seat part 100. Since the adjusting mechanism 500 disposed between the back rest part 200 and the seat part 100 is subjected to a large force at the time of collision, the strength of the adjusting mechanism 500 can be enhanced by the locking member 510, which can help prevent deformation of the child carrier at the time of collision. In the first embodiment, the locking member 510 is mounted on the seat part 100. In other embodiments, the locking member 510 may also be integrally formed on the seat part 100, as long as the structural strength between the adjusting mechanism 500 and the seat part 100 can be enhanced. In addition, the locking member 510 is disposed at an upper edge of the seat part 100 or the back rest part 200, and is as far away from the pivot structure 400 as possible. In this way, stress points of the whole child carrier are dispersed, making the force distribution on the child carrier more uniform, avoiding stress concentration and ensuring an impact performance of the child carrier when being impacted.

The configuration and working principle of the above adjusting mechanism 500 are relatively simple. The detent member 520 can enter or retract from the locking recess 511 by controlling the position of the first operating member 530, so that the angle between the seat part 100 and the back rest part 200 can be adjusted. This process is convenient to operate and is not easy to be stuck, and the stability of the angle adjustment can be effectively improved.

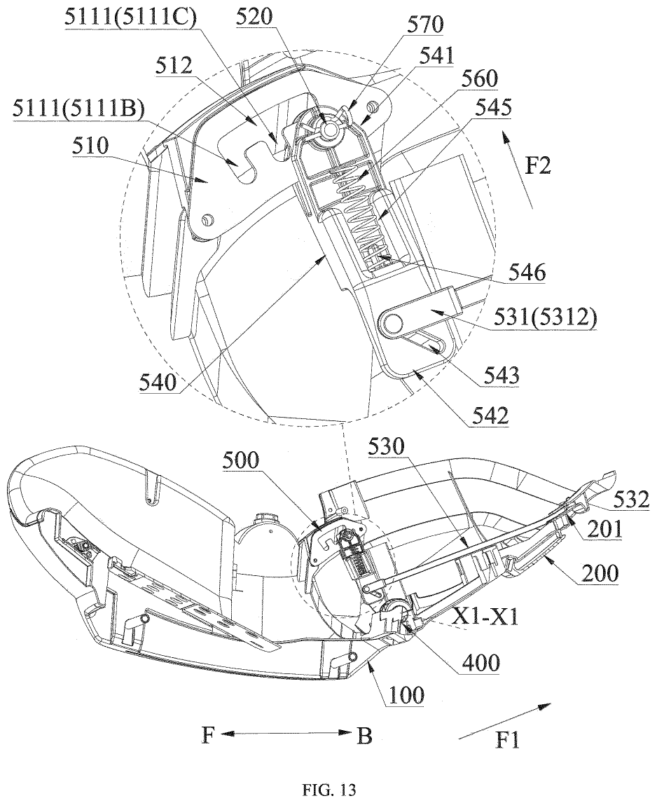

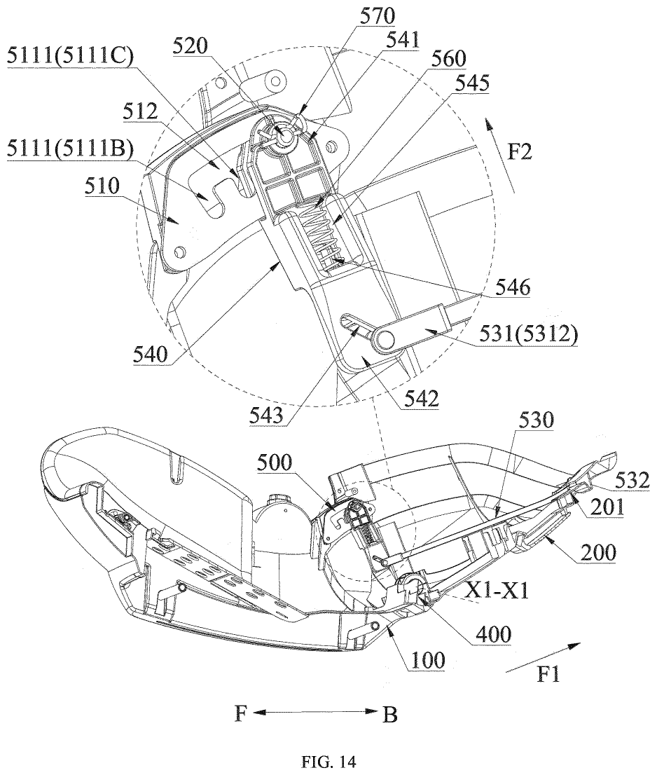

Referring to FIGS. 13 to 15, in some examples, the locking recess 511 includes at least two locking grooves 5111. A sliding recess 512 is formed on the locking member 510. The sliding recess 512 is in communication with each of the locking grooves 5111, and a groove wall of the sliding recess 512 and groove walls of the locking grooves 5111 enclose a closed structure. The detent member 520 is movably disposed in the sliding recess 512 and the locking grooves 5111. When the first operating member 530 is in the locked position (see FIGS. 11 and 13), the detent member 520 is located in one of the locking grooves 5111, and the back rest part 200 is fixed relative to the seat part 100. When the detent member 520 is located in different locking grooves 5111, the angles between the back rest part 200 and the seat part 100 are different, that is, the child carrier may be set to different back rest angle correspondingly. When the first operating member 530 is in the unlocked position (see FIG. 14), the detent member 520 is located in the sliding recess 512, and the back rest part 200 is pivotable relative to the seat part 100.

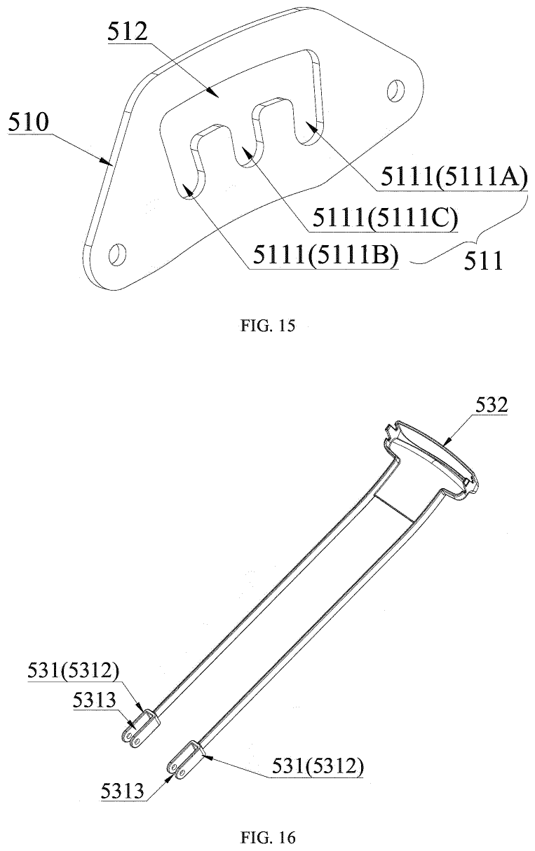

Specifically, in the first embodiment, as shown in FIG. 15, one of the locking grooves 5111 is referred to as a first locking groove 5111A, and another of the locking grooves 5111 is referred to as a second locking groove 5111B. The sliding recess 512 is in communication with the first locking groove 5111A and the second locking groove 5111B. In this way, the detent member 520 can be movably inserted into the sliding recess 512, the first locking groove 5111A and the second locking groove 5111B. Specifically, when the first operating member 530 is in the locked position, the detent member 520 may be located in the first locking groove 5111A or the second locking groove 5111B. More specifically, when the detent member 520 is located in the first locking groove 5111A, the seat part 100 and the back rest part 200 are arranged at a first angle, and the child carrier 1000 is in the first usage state. When the detent member 520 is located in the second locking groove 5111B, the seat part 100 and the back rest part 200 are arranged at a second angle, the first angle is greater than the second angle, and the child carrier 1000 is in the second usage state. In the first embodiment, as shown in FIGS. 11 and 13, when the detent member 520 is located in the first locking groove 5111A, the child carrier is in the first usage state, and in this case, the angle between the back rest part 200 and the seat part 100 is referred to as the first angle. When the detent member 520 is located in the second locking groove 5111B, the child carrier is in the first usage state, and in this case, the angle between the back rest part 200 and the seat part 100 is referred to as the second angle. The first angle is greater than the second angle.

Referring to FIGS. 13 to 15, in some examples, when more than three locking grooves 5111 are provided, the locking grooves 5111 other than the first locking groove 5111A and the second locking groove 5111B may be considered as transitional grooves 5111C. Such transitional grooves 5111C are located between the first locking groove 5111A and the second locking groove 5111B and in communication with the sliding recess 512. For example, in the first embodiment, there are three locking grooves 5111, including the first locking groove 5111A, the second locking groove 5111B and the transitional groove 5111C. The transitional groove 5111C is located between the first locking groove 5111A and the second locking groove 5111B. For example, in other embodiments, there may be four locking grooves 5111, including the first locking groove 5111A, the second locking groove 5111B, and two transitional grooves 5111C. The two transitional grooves 5111C are located between the first locking groove 5111A and the second locking groove 5111B. When the detent member 520 is located in one of such transitional grooves 5111C, a third angle is formed between the seat part 100 and the back rest part 200. The third angle is greater than the second angle and less than the first angle. In this case, the child carrier is in a transition state between the first usage state and the second usage state. That is, when the infant car seat is in the transition state, the angle between the back rest part 200 and the seat part 100 is between the first angle and the second angle. Specifically, the larger the number of the transitional grooves 5111C, the smaller the adjustment interval of the angle between the back rest part 200 and the seat part 100. Further, the user can more accurately adjust the angle between the back rest part 200 and the seat part 100, so that the state of the child carrier adapts more to the riding needs of the child, and the comfort of the child carrier is improved.

Referring to FIGS. 7 and 13 to 15, the sliding recess 512 is located above the first locking groove 5111A, the second locking groove 5111B, and the transitional groove 5111C, that is, the locking recess 511 is closer to the pivot structure 400 (or closer to a pivotal axis X1-X1 between the seat part 100 and the back rest part 200) relative to the sliding recess 512. When it is necessary to adjust the angle between the seat part 100 and the back rest part 200, the detent member 520 moves upward along the first locking groove 5111A, the second locking groove 5111B or the transitional groove 5111C into the locking recess 511. When it is necessary to lock the angle between the seat part 100 and the back rest part 200, the detent member 520 moves downward from the locking recess 511 into the first locking groove 5111A, the second locking groove 5111B or the transitional groove 5111C.

In some examples, the locking grooves 5111 (i.e., the first locking groove 5111A, the second locking groove 5111B, and the transitional groove 5111C) are spaced apart in a circumferential direction about the pivotal axis X1-X1 between the seat part 100 and the back rest part 200. It should be noted that the pivotal axis X1-X1 is the rotational axis of the pivot member 420 pivoting in the pivot groove 410. The sliding recess 512 has an arc-shaped structure, and an arc center of the sliding recess 512 is located on the pivotal axis X1-X1. In this way, when the detent member 520 retracts from the first locking groove 5111A, the second locking groove 5111B, or the transitional groove 5111C into the sliding recess 512, the detent member 520 can be moved within the sliding recess 512 by pivoting the back rest part 200.

In the first embodiment, as shown in FIG. 15, since the arc of the sliding recess 512 is short, the sliding recess 512 may be approximately linear. In other embodiments, the sliding recess 512 may be linear, as long as the sliding of the detent member 520 in the sliding recess 512 is not blocked by the respective locking grooves 5111A, 5111C, 5111B.

In some examples, the first operating member 530 may be operatively connected to the detent member 520 directly. In other alternative embodiments, the first operating member 530 may be operatively connected to the detent member 520 indirectly. For example, as shown in FIGS. 13 and 14, the adjusting mechanism 500 may further include a sliding transmission member 540. The first operating member 530 is operatively connected to the detent member 520 through the sliding transmission member 540. Specifically, the sliding transmission member 540 includes a connecting part 541 and a transmission part 542. The detent member 520 is arranged at the connecting part 541, and the transmission part 542 defines a guide groove 543. The guide groove 543 extends obliquely with respect to a moving direction (a first direction F1) of the first operating member 530. Specifically, in the first embodiment, as shown in FIGS. 11 to 14, the locking member 510 is mounted on the seat part 100. The first operating member 530 is movably mounted on the back rest part 200 and includes a drive part 531. The drive part 531 is slidable within the guide groove 543 to drive the sliding transmission member 540 to move the detent member 520 in a second direction F2 relative to the locking member 510, so as to switch the detent member 520 between the sliding recess 512 and the locking recess 511. It should be noted that, in the first embodiment, the moving direction of the first operating member 530 (that is, the first direction F1) is the same as an extending direction of the back rest part 200 in the front-rear direction, and the first direction F1 is perpendicular to the transverse width direction of the seat part 100 or the back rest part 200. The moving direction (i.e., the second direction F2) of the sliding transmission member 540 and the detent member 520 is perpendicular to both the first direction F1 and the transverse width direction of the seat part 100 or the back rest part 200. Most of the detent members 520 in the existing child carriers are moved in the transverse width direction of the seat part 100 or the back rest part 200 to lock and unlock the back rest part 200 with respect to the seat part 100, while in the first embodiment, the detent member 520 moves in the direction perpendicular to the transverse width direction of the seat part 100 or the back rest part 200 to lock and unlock the back rest part 200 with respect to the seat part 100, so that the moving stroke and path of the detent member 520 can be arranged more flexibly.

Referring to FIGS. 11 and 16, in some examples, the drive part 531 includes a latch 5311 and a pull block 5312. The pull block 5312 has a U-shaped structure and defines a first clamping chamber 5313. The first clamping chamber 5313 is configured to clamp the transmission part 542 of the sliding transmission member 540. The latch 5311 extends through a sidewall of the first clamping chamber 5313 and the guide groove 543 sequentially, and then is connected to another sidewall of the first clamping chamber 5313. In this way, the latch 5311 is not easily disengaged from the guide groove 543 when sliding in the guide groove 543, thereby improving the stability of the drive connection between the first operating member 530 and the sliding transmission member 540.

Referring to FIGS. 2, 13 and 14, in some examples, the first operating member 530 further includes an operation part 532. The operation part 532 is located on the side of the back rest part 200 facing away from the riding space 300 and at the rear end of the back rest part 200. The operation part 532 extends through an operation hole 201 of the back rest part 200 and then is exposed, so as to be operated and connected to the drive part 531. In this way, the user can directly control the first operating member 530 to switch between the locked position and the unlocked position through the operation part 532, and further control the sliding of the drive part 531 in the guide groove 543.

Referring to FIGS. 13, 14 and 17, in some examples, the guide groove 543 includes a first groove end 5431 and a second groove end 5432, which are oppositely disposed. Specifically, the first groove end 5431 is closer to the locking member 510 than the second groove end 5432. The second groove end 5432 is closer to the operation part 532 than the first groove end 5431 in the moving direction (i.e., first direction F1) of the first operating member 530. More specifically, when the first operating member 530 is in the locked position (see FIG. 13), the drive part 531 is located at the first groove end 5431. When the first operating member 530 is in the unlocked position (see FIG. 14), the drive part 531 is located at the second groove end 5432. Specifically, when the user pulls the operation part 532 to move the drive part 531 from the first groove end 5431 to the second groove end 5432, the drive part 531 may drive the sliding transmission member 540 to move upward relative to the locking member 510 in a guide direction of the locking groove 5111 (i.e., the first locking groove 5111A, the second locking groove 5111B, or the transitional groove 5111C), and further, may drive the detent member 520 to move from the locking groove 5111 to the sliding recess 512. In this way, the detent member 520 is not restricted by the locking groove 5111, so that the detent member 520 can move in the circumferential direction of the pivotal axis X1-X1 in the sliding recess 512. Therefore, when the first operating member 530 is in the unlocked position, that is, when the detent member 520 moves to the sliding recess 512, the user may adjust the state of the child carrier by pushing the back rest part 200 to pivot about the pivotal axis X1-X1.

Referring to FIG. 11, in some examples, when the locking member 510 is mounted on an inner wall of the seat part 100, a gap is formed between the locking member and the inner wall. The connecting part 541 of the sliding transmission member 540 has a U-shape structure, and defines a second clamping chamber 544 for clamping the locking member 510. The detent member 520 extends through a sidewall of the second clamping chamber 544, and the locking recess 511 or the sliding recess 512 of the locking member 510 in sequence, and is then connected to another sidewall of the second clamping chamber 544. In this way, the detent member 520 can be prevented from be disengaged from the locking recess 511 or the sliding recess 512 during movement, thereby improving the stability of the angle adjustment of the child carrier.

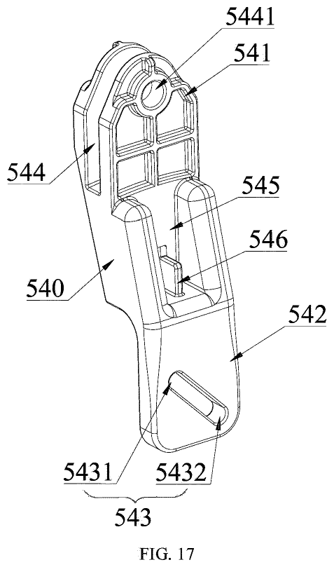

In the first embodiment, as shown in FIGS. 11 and 12, the detent member 520 is connected to the connecting part 541 of the sliding transmission member 540 through a latching member 570. Specifically, the detent member 520 is connected to the latching member 570 after extending through a perforation 5441 on the sidewall of the second clamping chamber 544 (see FIG. 17). The size (in particular, the length L1) of the latching member 570 is greater than the diameter of the perforation 5441, so that the latching member 570 can abut against an edge of the perforation 5441 to prevent the detent member 520 from being disengaged from the connecting part 541 through the perforation 5441.

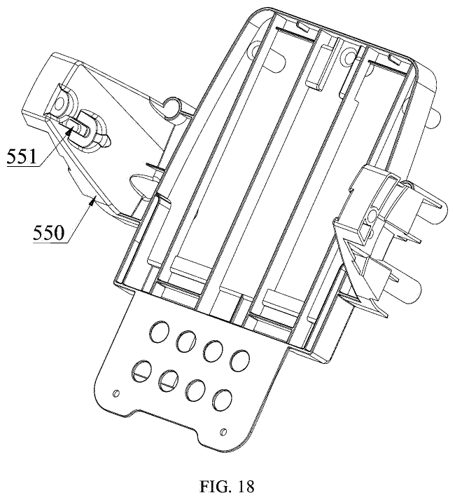

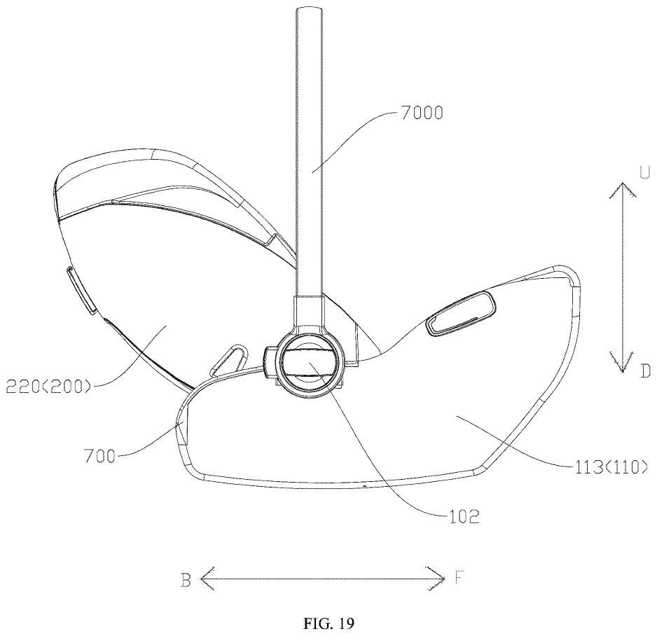

Referring to FIGS. 11 and 12, in some examples, the adjusting mechanism 500 may also include a mounting bracket 550. Optionally, the mounting bracket 550 is fixedly mounted to the back rest part 200, or the mounting bracket 550 is removably mounted to the back rest part 200. As shown in FIGS. 12 and 18, a strip-shaped sliding groove 551 is formed on the mounting bracket 550. The strip-shaped sliding groove 551 extends in a direction from the locking recess 511 to the sliding recess 512. As shown in FIGS. 12 and 13, the detent member 520 extends through the strip-shaped sliding groove 551 and the connecting part 541, and is movably inserted into the sliding recess 512 or the locking recess 511. Further, the size (in particular, the length L1) of the latching member 570 is greater than the width L2 of the strip-shaped sliding groove 551, so that the detent member 520 can be prevented from being disengaged from the strip-shaped sliding groove 551 during movement. When the detent member 520 moves to the sliding recess 512, the user pushes the back rest part 200 to pivot the mounting bracket 500 along with the back rest part 200 about the pivotal axis X1-X1. At the same time, the mounting bracket 500 pushes the detent member 520 to pivot about the pivotal axis X1-X1 in the locking recess 511, thereby changing the angle between the back rest part 200 and the seat part 100.

Referring to FIGS. 11 and 12, in some examples, the adjusting mechanism 500 may further include a reset member 560. The reset member 560 abuts between the mounting bracket 550 and the sliding transmission member 540. The reset member 560 is configured to drive the sliding transmission member 540 to reset, so that the detent member 520 moves from the sliding recess 512 to the locking recess 511 (i.e., the first locking groove 5111A, the second locking groove 5111B or the transitional groove 5111C). Specifically, the reset member 560 may be a spring or other type of elastic member. In the first embodiment, the reset member 560 is a spring. As shown in FIG. 17, a third clamping chamber 545 is formed on the sliding transmission member 540. As shown in FIGS. 12 and 13, the spring is accommodated in the third clamping chamber 545. An end of the spring abuts against a bottom wall of the third clamping chamber 545, and another end of the spring abuts against the mounting bracket 550. In this way, the spring can be prevented from being displaced during compression or resetting. More specifically, a limiting boss 546 is formed in the third clamping chamber 545. The spring is sleeved on the limiting boss 546, so that the spring can be further prevented from being displaced.

The operation process of the adjustment of the state of the child carrier (angle between the back rest part 200 and the seat part 100) will be described below referring to FIGS. 6, 7, and 12 to 14.

As shown in FIG. 13, when the detent member 520 is located in the first locking groove 5111A, a groove wall of the first locking groove 5111A can restrict the detent member 520 from moving into other locking grooves 5111, and thus the back rest part 200 can be restricted from pivoting relative to the seat part 100, so that the child carrier can be maintained in the lie-flat state.

As shown in FIG. 14, when the user needs to adjust the state of the child carrier, that is, when the user needs to switch the child carrier from the lie-flat state to the transition state or to the sitting state, the user can pull the operation part 532 upward in the first direction F1, so that the operation part 532 drives the drive part 531 to move upward in the first direction F1. When the operation part 532 is moved upward in the first direction F1, under the influence of the guide groove 543, the drive part 531 can drive the sliding transmission member 540 and the detent member 520 to move upward in the second direction F2 relative to the locking member 510, so that the detent member 520 retracts from the first locking groove 5111A into the sliding recess 512, and the reset member 560 is compressed. When the detent member 520 moves into the sliding recess 512, the back rest part 200 can be pushed so that the back rest part 200 pivots about the pivotal axis X1-X1 with respect to the seat part 100. At the same time, the mounting bracket 550, when pivoting with the back rest part 200, pushes the detent member 520 to move about the pivotal axis X1-X1 in the sliding recess 512. When the detent member 520 moves directly above the transitional groove 5111C or the second locking groove 5111B, the user may release the operation part 532. In this case, the reset member 560 resets, and the reset member 560 pushes the sliding transmission member 540 to move downward in an opposite direction of the second direction F2, so that the detent member 520 can enter the transitional groove 5111C or the second locking groove 5111B from the sliding recess 512. Specifically, during the downward movement of the sliding transmission member 540 in the opposite direction of the second direction F2, under the influence of the guide groove 543, the drive part 531 can be moved downward in an opposite direction of the first direction F1, so that the operation part 532 is reset and the first operating member 530 is in the locked position.

In some examples, one or more adjusting mechanisms 500 may be provided. Specifically, in the first embodiment, two adjusting mechanisms 500 are provided. The two adjusting mechanisms 500 are spaced apart from each other in the left-right direction of the child carrier. In some examples, the first operating members 530 in the adjusting mechanisms 500 are arranged in parallel. The operation parts 532 of the first operating members 530 are independent from each other. When it is necessary to adjust the state of the child carrier, the two operation parts 532 can be operated at the same time. In the first embodiment, as shown in FIG. 16, the first operating members 530 share one operation part 532, that is, the drive parts 531 of the first operating members 530 are operated by the same operation part 532. In this way, it is possible to simultaneously control the two drive parts 531 through this operation part 532, thereby simultaneously controlling the two sliding transmission members 540 and the two detent members 520.

The child carrier and the adjusting mechanism 500 thereof according to the first embodiment of the present application have at least the following technical effects.

The adjusting mechanism 500 is arranged between the seat part 100 and the back rest part 200 for adjusting the angle between the seat part 100 and the back rest part 200. The locking member 510 is mounted on the seat part 100 or the back rest part 200, and the first operating member 530 is movably mounted on the seat part 100 or the back rest part 200. Since the detent member 520 is movably disposed on the locking member 510 and the first operating member 530 is operatively connected to the detent member 520, the position of the detent member 520 on the locking member 510 can be directly controlled by controlling the first operating member 530. Specifically, since the first operating member 530 has the locked position and the unlocked position on its moving path, when the first operating member 530 is in the locked position, the detent member 520 is limited in the locking recess 511 on the locking member 510, so that the back rest part 200 can be fixed with respect to the seat part 100, and the angle between the back rest part 200 and the seat part 100 can remain unchanged. When the first operating member 530 moves to the unlocked position, the first operating member 530 drives the detent member 520 to retract from the locking recess 511, so that the back rest part 200 can pivot relative to the seat part 100 to adjust the angle between the back rest part 200 and the seat part 100. The configuration and working principle of the above adjusting mechanism 500 are relatively simple. The detent member 520 can enter or retract from the locking recess 511 by controlling the position of the first operating member 530, so that the angle between the seat part 100 and the back rest part 200 can be adjusted. This process is convenient to operate and is not easy to be stuck, and the stability of the angle adjustment can be effectively improved.

As shown in FIGS. 19 to 21, a second embodiment of the present application provides a child carrier 1000. Similar to the child carrier of the first embodiment, the child carrier of the second embodiment of the present application also includes the seat part 100 and the back rest part 200. Different from the first embodiment, in the child carrier of the second embodiment, the back rest part 200 and the seat part 100 are pivotally connected at a fixed first pivot point 101, and the child carrier of the second embodiment further includes an adjusting mechanism arranged between the back rest part 200 and the seat part 100, so that the back rest part 200 can be switched between at least two angular positions with respect to the seat part 100. In the description of the second embodiment, in order to distinguish its description from that of the first embodiment, the adjusting mechanism is referred to as an adjusting device 600 hereinafter. In other words, the adjusting device 600 is a modification of the adjusting mechanism 500.

Specifically, the seat part 100 may include the housing 110 and the leg rest part 150. The back rest part 200 is pivotally connected to the housing 110, to form a riding space 300, for carrying a child. In the second embodiment, the leg rest part 150 and the housing 110 are integrally formed.

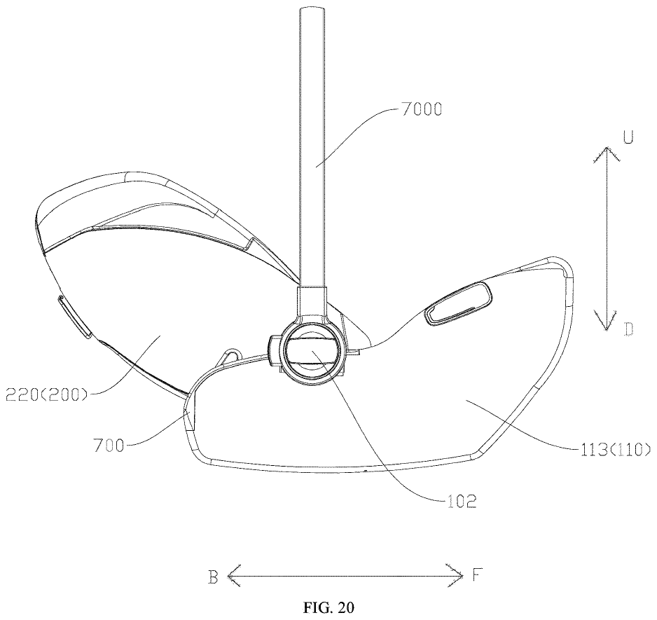

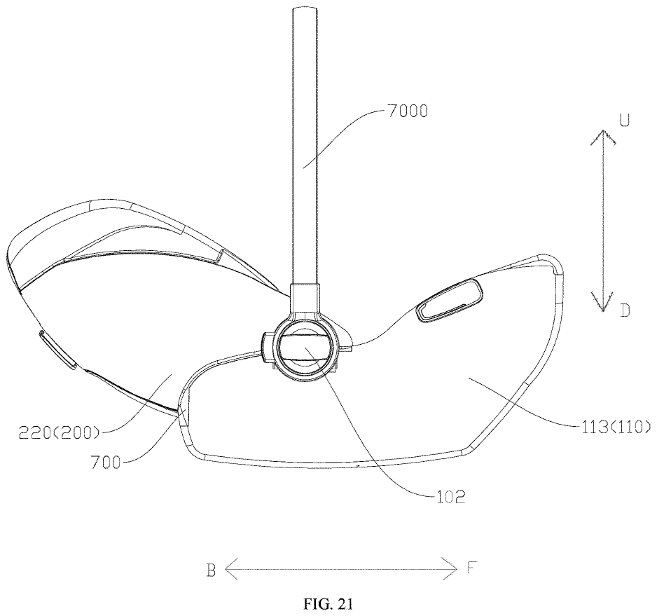

The back rest part 200 has at least two angular positions with respect to the housing 110 to meet different riding needs of children. For example, a first angular position of the back rest part 200 with respect to the housing 110 in FIG. 19 is suitable for the sitting posture of a child, a third angular position of the back rest part 200 with respect to the housing 110 in FIG. 20 is suitable for the reclining posture of a child, a second angular position of the back rest part 200 with respect to the housing 110 in FIG. 21 is suitable for the lie-flat posture of an child, It should be understood that the back rest part 200 may have more than three or less than three angular positions with respect to the housing 110 according to actual needs, and which is not limited in the present application. In addition, it should be understood that a correspondence relationship between the postures of the child on the child carrier 1000, and the first angular position, the second angular position and the third angular position of the back rest part 200 and the housing 110 is merely exemplary, and the first angular position, the second angular position and the third angular position does not necessarily correspond to the sitting posture, the lie-flat posture, and the reclining posture of the child respectively. For example, the first angular position may be suitable for the lie-flat posture of the child, the second angular position may be suitable for the reclining posture of the child, the third angular position may be suitable for the sitting posture of the child, and which is not limited in the present application.

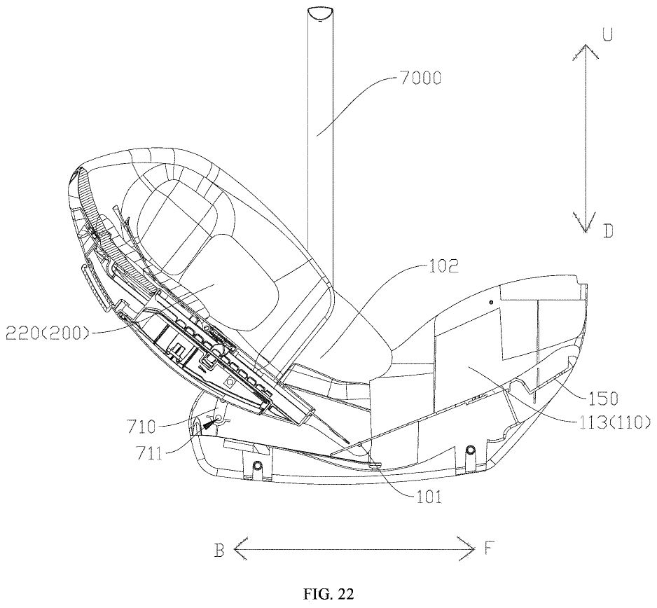

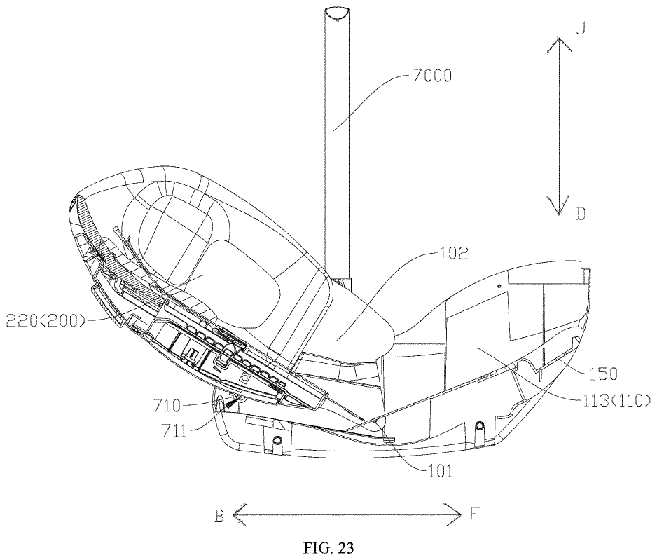

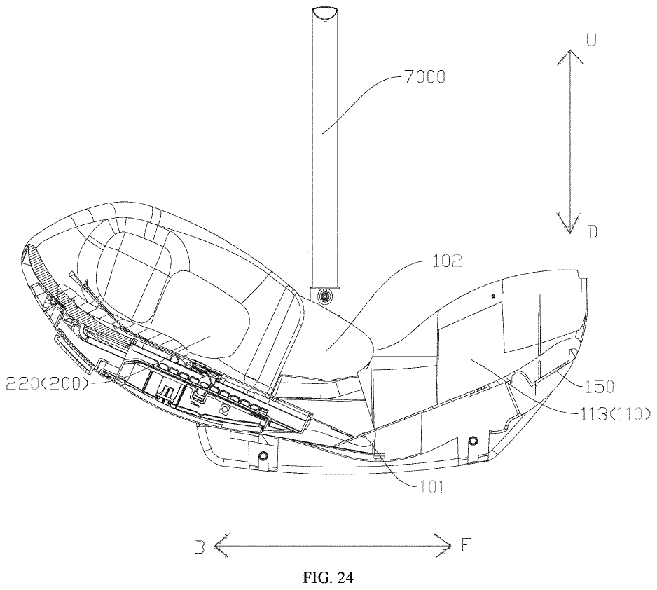

As shown in FIGS. 22 to 24, the housing 110 is provided with a handle coupling part 102. The handle coupling part 102 is configured to be coupled with a handle 7000 of the child carrier 1000. A direction that the child faces when riding on the child carrier 1000 is defined as a front direction, and a direction from a bottom edge of the housing 110 to the handle coupling part 102 is defined as an upward direction. The first pivot point 101 is located in front of the handle coupling part 102, which improves the force-bearing behavior of the child carrier 1000 when subject to impact. Further, the first pivot point 101 is located lower, which is beneficial to lowering the center of gravity of the child riding on the child carrier 1000 and thus improving the safety of the child. FIGS. 19 to 24 and subsequent figures still show the front direction with arrow “F,” the rear direction with arrow “B,” the upward direction with arrow “U” and the downward direction with arrow “D.” The arrow “F” refers to the direction that the child faces when riding on the child carrier 1000.

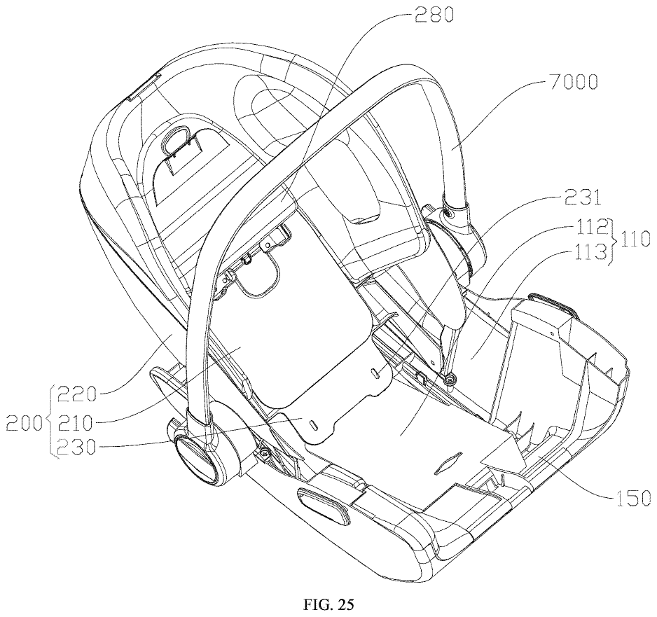

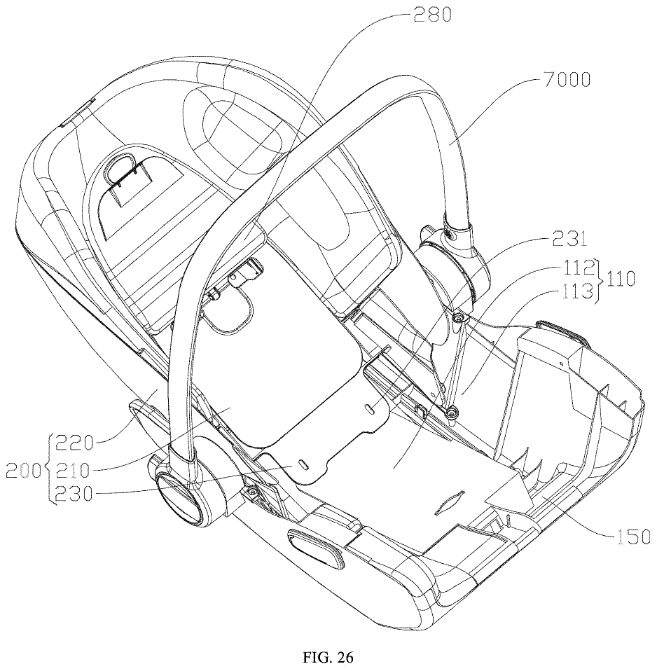

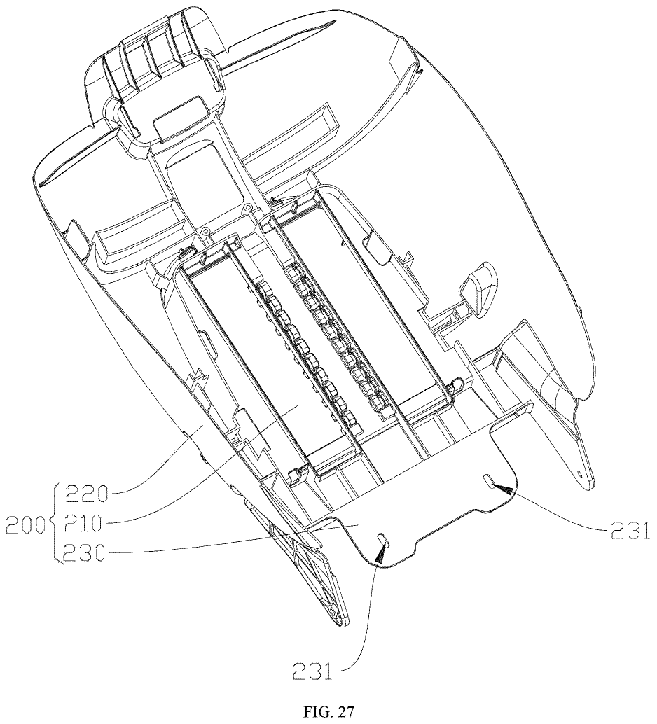

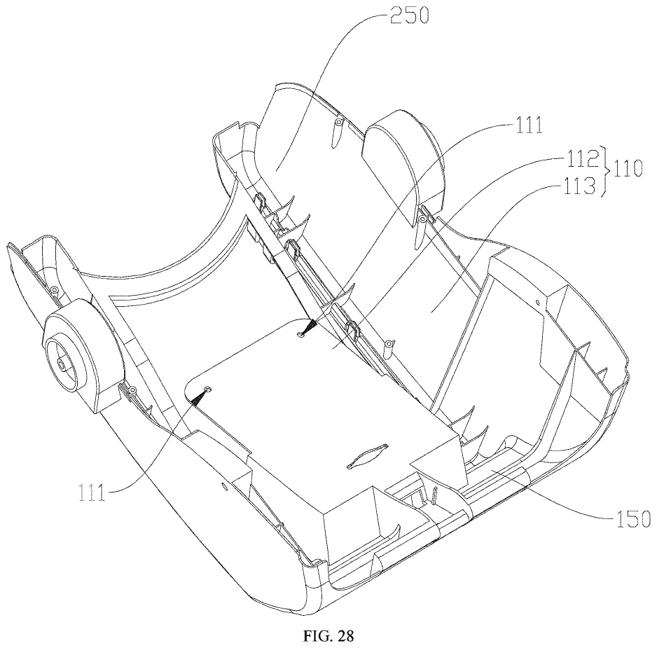

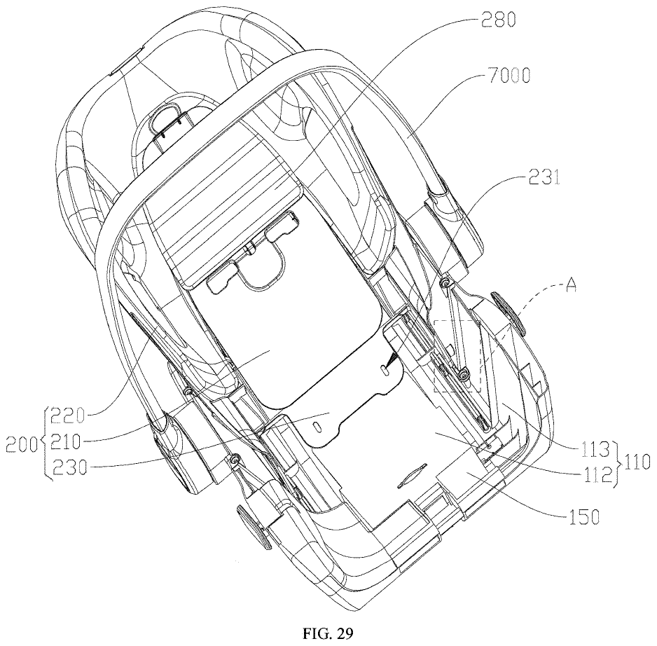

FIGS. 25 and 26 are schematic perspective views of the child carrier 1000 in this embodiment. The first angular position of the back rest part 200 with respect to the housing 110 of the child carrier 1000 shown in FIG. 25 is suitable for the sitting posture of a child. The second angular position of the back rest part 200 with respect to the housing 110 of the child carrier 1000 shown in FIG. 26 is suitable for the lie-flat posture of a child. Specifically, referring also to FIG. 27, the back rest part 200 includes a back rest body 210, back rest side plates 220 respectively connected to both sides of the back rest body 210, and a back rest extension 230 connected to a lower side of the back rest body 210. When the back rest part 200 is pivotally connected to the housing 110, the back rest extension 230 is located on a side of the housing 110 facing the riding space. A head rest part 280 for supporting a head of a child is disposed on a side of the back rest body 210 away from the back rest extension 230. The head rest part 280 is slidably connected to the back rest body 210, so that an arrangement position of the head rest part 280 with respect to the back rest body 210 can be adjusted according to a body shape of the child. Referring to FIG. 28, the housing 110 is an integrally formed structure, and generally includes a housing body 112 and housing side plates 113 respectively connected to both sides of the housing body 112. The leg rest part 150 is fixed to a side of the housing body 112 away from the back rest extension 230, for supporting legs of the child. In this embodiment, the leg rest part 150 and the housing body 112 are integrally formed.

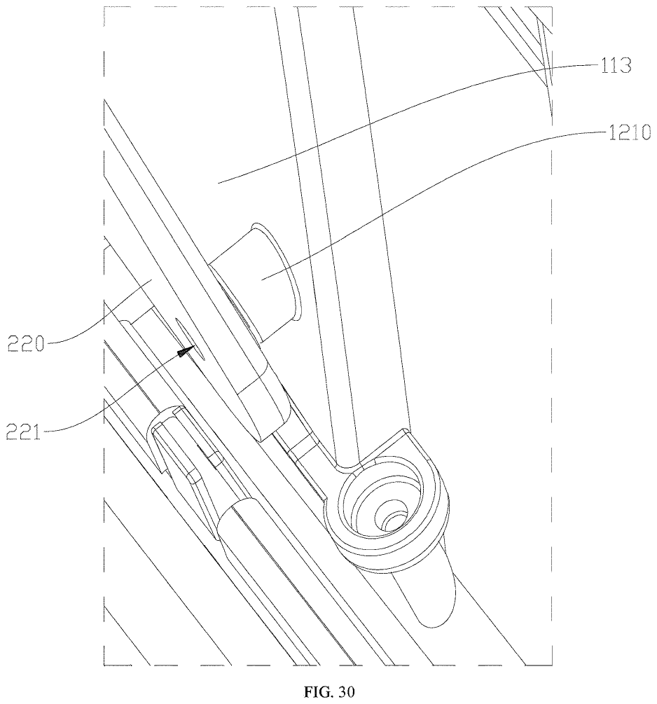

As shown in FIG. 29, the two back rest side plates 220 of the back rest part 200 are pivotally connected to the two housing side plates 113 of the housing 110, respectively. FIG. 30 is an enlarged view of a portion A shown in FIG. 29, showing a specific pivoting configuration between one of the back rest side plates 220 and a corresponding housing side plate 113. At least a lower end of the back rest side plate 220 is located at an inner side of the corresponding housing side plate 113. A pivot hole 221 is formed at a lower end of the back rest side plate 220. A pivot protrusion 1210 is formed at the inner side of the housing side plate 113. A connection groove (not shown) is formed on the pivot protrusion 1210. A connection shaft (not shown) extends through the pivot hole 221 and the connection groove on the pivot protrusion 1210 to realize a pivot connection between the back rest side plate 220 and the corresponding housing side plate 113. In other embodiments, a position of the pivot hole 221 and a position of the pivot protrusion 1210 may be interchanged. Alternatively, the back rest side plate 220 and the corresponding housing side plate 113 may be pivotally connected by other structures.

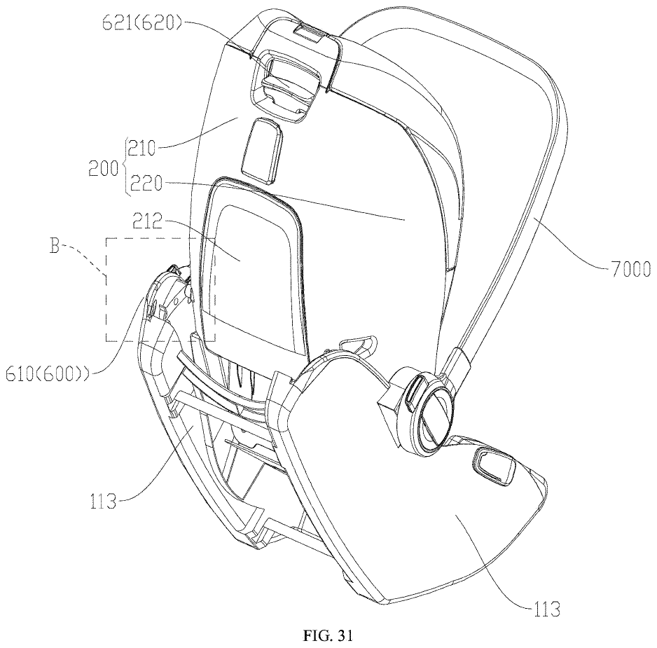

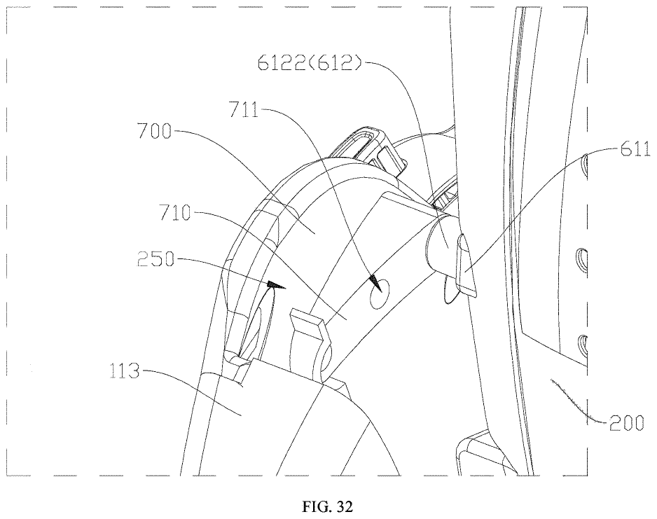

As shown in FIG. 31, the adjusting device 600 includes a locking mechanism 610 and an operating mechanism 620.

The locking mechanism 610 is disposed between the housing 110 and the back rest part 200. The locking mechanism 610 has a locked state, in which the back rest part 200 is fixed in one of the at least two angular positions (e.g., at the first angular position or the second angular position), and an unlocked state, in which the back rest part 200 is allowed to switch between the at least two angular positions (e.g., between the first angular position and the second angular position).

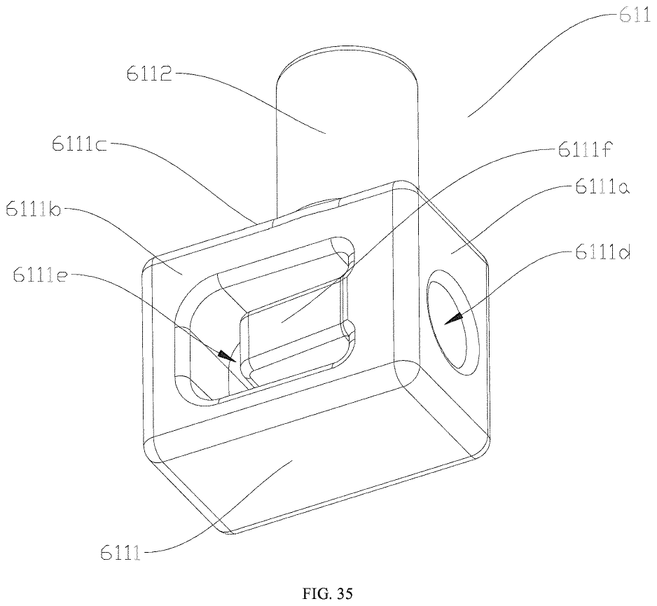

In this embodiment, as shown in FIG. 31, two locking mechanisms 610 are respectively disposed on the back rest side plates 220 and the housing side plates 113 on both sides of the child carrier 1000, so as to realize smooth adjustment of the angular position of the back rest part 200 with respect to the seat part 100. FIG. 32 is an enlarged view of a portion B shown in FIG. 31, showing a specific configuration of the locking mechanism 610 on one of the sides. A mounting part 710 described below is disposed at an upper edge of a surface of the housing 110 facing the riding space. At least two engaging grooves 711 are formed on the mounting part 710. The at least two engaging grooves 711 include a third engaging groove 711 and a fourth engaging groove 711. The at least two engaging grooves 711 are arranged in a direction intersected with the front-rear direction. Referring to FIGS. 32 to 35, the locking mechanism 610 includes an actuator 611 and a locking pin 612. The actuator 611 includes an actuator body 6111 and a positioning protrusion 6112 protruding from a side of the actuator body 6111. In this embodiment, the actuator 611 is integrally formed. In other embodiments, the actuator 611 may be formed by connecting the actuator body 6111 to the positioning protrusion 6112 by welding, riveting, or the like. The actuator body 6111 has a generally rectangular parallelepiped structure. The actuator body 6111 has a first side surface 6111a, a second side surface 6111b, and a third side surface 6111c. The first side surface 6111a, the second side surface 6111b, and the third side surface 6111c are adjacent to each other. A mounting hole 6111d is formed on the first side surface 6111a of the actuator body 6111. An end of the locking pin 612 is inserted into the mounting hole 6111d. A generally rectangular mounting groove 6111e is formed on the second side surface 6111b of the actuator body 6111. The mounting groove 6111e is in communication with the mounting hole 6111d. In this embodiment, the mounting groove 6111e is a rectangular groove. A side groove wall of the rectangular groove is connected with an elastic finger 6111f. A convex portion (not shown) is formed on one of the locking pin 612 and the elastic finger 6111f, and a recess portion (not shown) is formed on another of the locking pin 612 and the elastic finger 6111f. When the locking pin 612 is inserted into the mounting hole 6111d, the convex portion is inserted and fits into the recess portion, and the locking pin 612 is pressed and fixed into the mounting hole 6111d by an elastic force of the elastic finger 6111f. In this embodiment, the convex portion is formed on the elastic finger 6111f, and the recess portion is formed on the locking pin 612. The positioning protrusion 6112 protrudes from the third side surface 6111c of the actuator body 6111. An extending direction of the mounting hole 6111d intersects with an extending direction of the positioning protrusion 6112. A portion of the locking pin 612 that is located outside the mounting hole 6111d forms a locking part 6122. The locking part 6122 can be engaged with one of the at least two engaging grooves 711 (e.g., the third engaging groove 711 or the fourth engaging groove 711) to fix the back rest part 200 in an angular position (e.g., the first angular position or the second angular position).

Further, the mounting part 710 is located behind the handle coupling part 102. In the foregoing, the first pivot point 101 is located at a lower front side of the handle coupling part 102, that is, the first pivot point 101 and the mounting part 710 are respectively located on both sides of the handle coupling part 102. In this way, a better stress structure is formed. In the event of vehicle collision, an impact force is dispersed on the child carrier 1000, and the child carrier 1000 is less likely to be damaged.

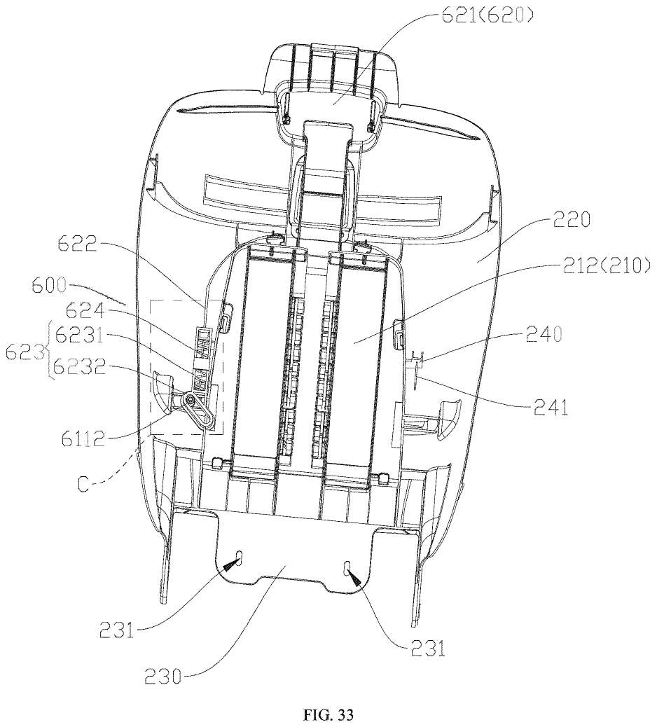

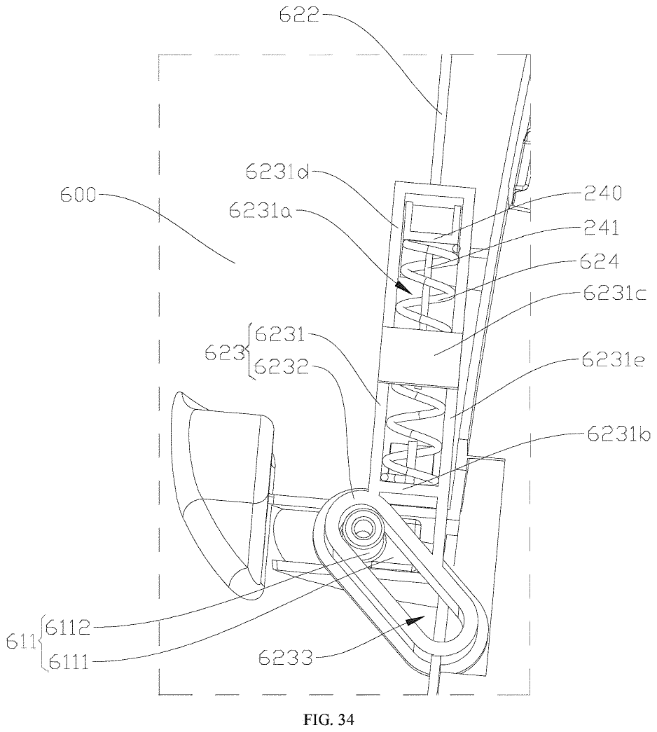

As shown in FIGS. 33 and 34, the operating mechanism 620 includes a second operating member 621, a pulling member 622, a linkage member 623, and an operating reset member 624.

In this embodiment, the second operating member 621 is a pull handle, and is operatively disposed on a side of the back rest body 210 away from the back rest extension 230.

Two linkage members 623 are provided. The two linkage members 623 are respectively drivingly connected to the actuators 611 of the locking mechanisms 610 on both sides. Two pulling members 622 are provided correspondingly. Both ends of each pulling member 622 are respectively connected to the second operating member 621 and the linkage member 623 on the corresponding side. The two linkage members 623 are movably disposed on a side of the back rest part 200 facing away from the riding space. The linkage member 623 includes a mounting frame 6231 and a linkage part 6232 that are connected to each other.

The mounting frame 6231 has a generally rectangular frame structure and extends in a longitudinal direction of the back rest part 200. An end of the mounting frame 6231 is connected to the pulling member 622, and another end of the mounting frame 6231 is connected to the linkage part 6232. A receiving space 6231a is formed in the mounting frame 6231. The operating reset member 624 is received in the receiving space 6231a. In this embodiment, the operating reset member 624 is a spring. A first end of the operating reset member 624 is connected to or abuts against the linkage member 623, a second end of the operating reset member 624 is connected to or abuts against a stop member 240 on the back rest part 200. The operating reset member 624 is adapted to cause the linkage member 623 to drive the second operating member 621 to reset. In an embodiment, the stop member 240 is also arranged in the receiving space 6231a. A mounting base 6231b is disposed on a side of the mounting frame 6231 adjacent to the linkage part 6232 (or adjacent to the locking mechanism 610). The first end of the operating reset member 624 is fixed to the mounting base 6231b, and the second end of the operating reset member 624 is fixed to the stop member 240. Further, a guide member 241 is provided on the mounting frame 6231 or the stop member 240. The operating reset member 624 is sleeved on the guide member 241 to prevent the operating reset member 624 from being displaced during a biasing process. The mounting frame 6231 includes a first side part 6231d and a second side part 6231e, which are oppositely disposed. A stopper 6231c is connected to a substantially middle portion of the first side part 6231d and a substantially middle portion of the second side part 6231e to prevent the operating reset member 624 from being escaped from the receiving space 6231a.

As shown in FIG. 34, the linkage part 6232 also has a substantially rectangular structure. An extending direction of the linkage part 6232 intersects with an extending direction of the mounting frame 6231. For example, the extending direction of the linkage part 6232 can form a 45-degree angle with the extending direction of the mounting frame 6231. A sliding groove 6233 is formed on the linkage part 6232, and extends in the extending direction of the linkage part 6232. In other embodiments, the extending direction of the linkage part 6232 may not be intersected with the extending direction of the mounting frame 6231, as long as the extending direction of the sliding groove 6233 is ensured to be intersected with the extending direction of the mounting frame 6231. The positioning protrusion 6112 of the actuator 611 forms a first sliding cooperative part, and the sliding groove 6233 of the linkage member 623 forms a second sliding cooperative part. The positioning protrusion 6112 is inserted in the sliding groove 6233 and can move along the sliding groove 6233, so as to realize a sliding cooperation between the actuator 611 and the linkage member 623.

Further, referring to FIGS. 32 and 34, the locking part 6122 can move in a direction approaching or away from the mounting part 710, that is, can move in a direction approaching or away from one of the engaging grooves 711 (such as the third engaging groove 711 or the fourth engaging groove 711). The extending direction of the sliding groove 6233 is inclined with respect to a moving direction of the locking part 6122. Specifically, the sliding groove 6233 is inclined upward in a direction approaching the mounting part 710. In this embodiment, the sliding groove 6233 is inclined upward in a direction from an inside to an outside.

Specifically, the back rest body 210 includes a back rest plate 211 and a cover body 212 covering a side of the back rest plate 211 facing away from the riding space. The back rest plate 211 and the cover body enclose a mounting space. The actuator 611 and at least part of the locking pin 612 of the locking mechanism 610, and the pulling member 622 and the linkage member 623 of the operating mechanism 620 are mounted in this mounting space, so that the appearance of the child carrier is tidy and clean, and the associated parts of the locking mechanism 610 and the operating mechanism 620 can be protected from being damaged.

When the second operating member 621 is pulled, the second operating member 621 can pull the linkage member 623 to move in a direction approaching the second operating member 621 by the pulling member 622, that is, pull the linkage member 623 to move upward. The linkage member 623 drives the actuator 611 to move the locking pin 612 in a direction away from the mounting part 710 by the sliding cooperation between the sliding groove 6233 and the positioning protrusion 6112. That is, the locking pin 612 is moved in the direction away from the corresponding engaging groove 711 (for example, the third engaging groove 711) until the locking part 6122 of the locking pin 612 is disengaged from the corresponding engaging groove 711 (for example, the third engaging groove 711), and then the locking mechanism 610 is in the unlocked state. In this case, the back rest part 200 can pivot relative to the housing 110. When the back rest part 200 pivots relative to the housing 110 to a desired angular position, and the locking part 6122 faces another engaging groove 711 (for example, the fourth engaging groove 711), then the force for pulling the second operating member 621 can be removed. At this time, the linkage member 623 can move in the direction away from the second operating member 621, that is, move downward, under an elastic force of the operating reset member 624, so that the locking pin 612 moves in the direction approaching the mounting part 710 or another engaging groove 711 (for example, the fourth engaging groove 711) until the locking part 6122 of the locking pin 612 is inserted into the another engaging groove 711 (for example, the fourth engaging groove 711). In this way, the back rest part 200 realizes an adjustment of its angular position.

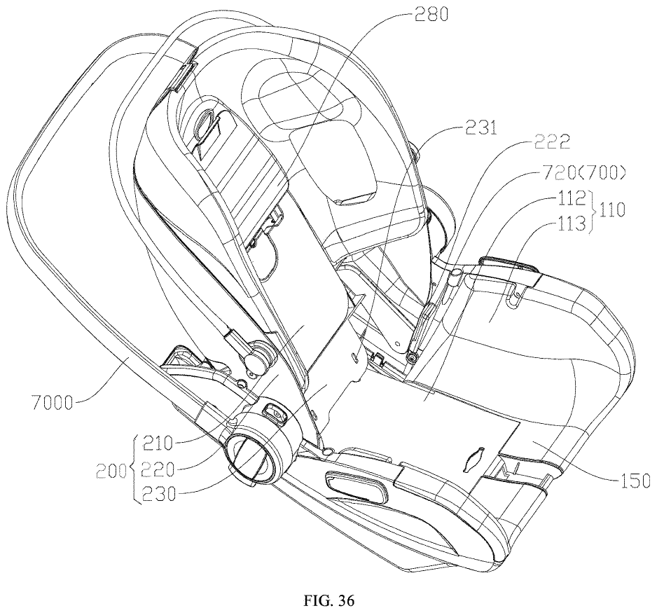

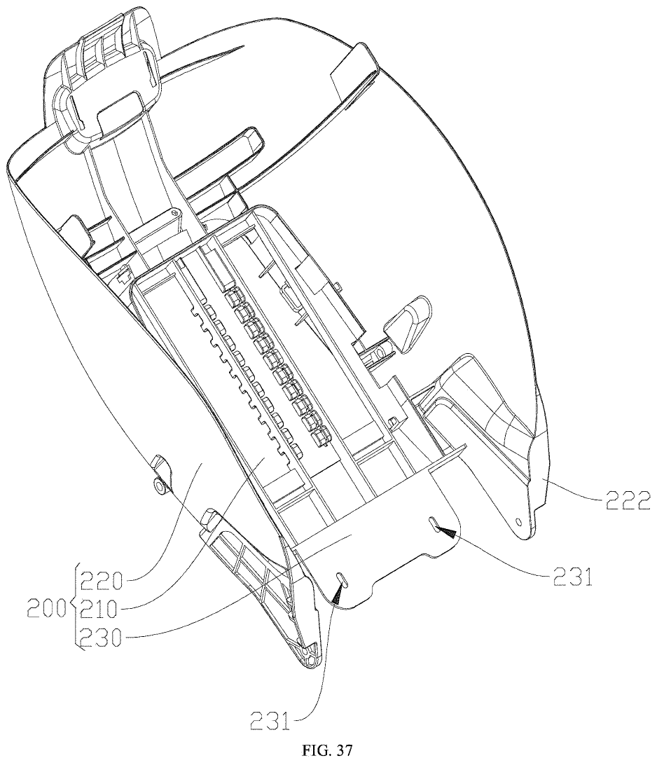

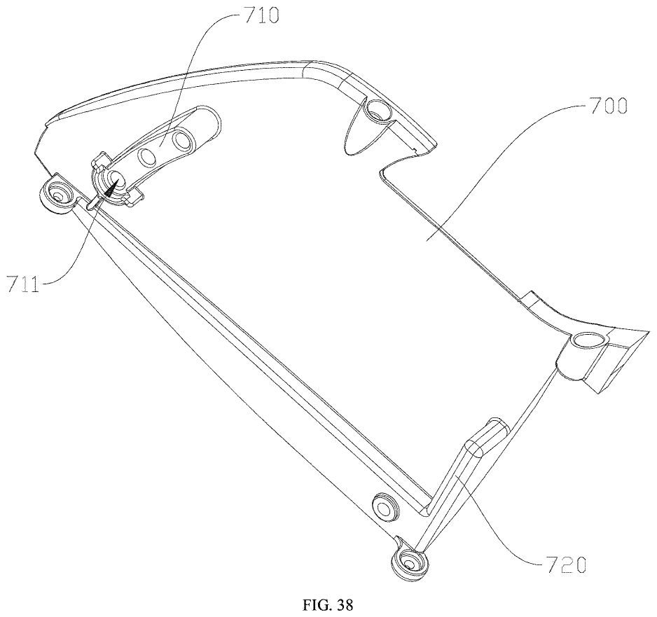

In an example, as shown in FIGS. 36 to 38, the child carrier 1000 further includes a mounting plate 700 having a generally rectangular plate-like structure. The mounting plate 700 is fixedly connected to the housing 110. Mounting parts 710 and limiting ribs 720 are respectively disposed on both sides of the mounting plate 700. Both the mounting part 710 and the limiting rib 720 protrude toward the riding space. In this embodiment, two mounting plates 700 are provided, and are fixedly connected to inner sides of the two housing side plates 113 of the housing 110 respectively. Edges of the two back rest side plates 220 adjacent to the back rest extension 230, that is, lower edges of the two back rest side plates 220, form stop surfaces 222. The back rest part 200 can pivot relative to the housing 110 until the stop surface 222 and the limiting rib 720 abut against each other, so as to limit a pivot angle of the back rest part 200 relative to the housing 110. In this embodiment, when the back rest part 200 pivots relative to the housing 110 until the state of the child carrier is suitable for the sitting posture of the child, the stop surface 222 abuts against the limiting rib 720. In this way, an excessive pivoting of the back rest part 200 with respect to the housing 110, which may cause a safety hazard or uncomfortable riding experience to the child, can be prevented.

Further, as shown in FIG. 32, the mounting part 710 protrudes toward the back rest part 200. An avoiding recess 250 corresponding to the mounting part 710 is formed on the back rest part 200, so as to allow the back rest part 200 to pivot relative to the housing 110.

Further, as shown in FIGS. 26 to 28, a sliding hole 231 is formed on the back rest extension 230. A connecting hole 111 is formed at a portion of the housing body 112 that is relatively distant from the leg rest part 150, that is, a portion of the housing body 112 that overlaps with the back rest extension 230. One of the sliding hole 231 and the connecting hole 111 is strip-shaped, and the sliding hole 231 and the connecting hole 111 are at least partially overlapped. A sliding pin (not shown) extends through the sliding hole 231 and the connecting hole 111 to guide the back rest part 200 to move with respect to the housing 110 in the front-rear direction. When the back rest part 200 pivots relative to the housing 110, the back rest extension 230 or the back rest part 200 is driven to move relative to the housing body 112 in the front-rear direction of the child carrier 1000. The movement of the back rest extension 230 or the back rest part 200 can be guided by the cooperation of the sliding pin, the sliding hole 231, and the connecting hole 111.

According to the child carrier 1000 of the second embodiment of the present application, the adjustment can be performed to meet a riding posture of the child by simply pivoting the back rest part 200, without involving a linkage between other components (for example, the back rest part and the leg rest part), so that the adjustment is convenient and the structure is simple.

Furthermore, it should be understood that the back rest assembly 200 shown in the second embodiment may also be applied to the child carrier of the first embodiment. Accordingly, a sliding hole 231 is formed on the back rest extension 230, and a connecting hole is also formed at a portion of the housing 110 corresponding to the back rest extension. A sliding pin (not shown) extends through the sliding hole 231 and the connecting hole to guide the back rest part 200 to move with respect to the housing 110 in the front-rear direction. When the back rest part 200 pivots relative to the housing 110, the back rest extension 230 or the back rest part 200 is driven to move relative to the housing 110 in the front-rear direction of the child carrier 1000. The movement of the back rest extension 230 or the back rest part 200 can be guided by the cooperation of the sliding pin, the sliding hole 231, and the connecting hole.

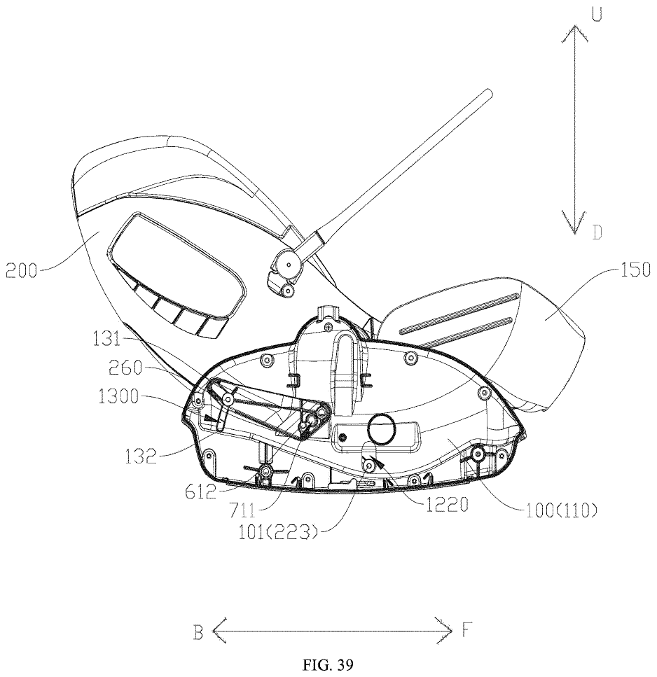

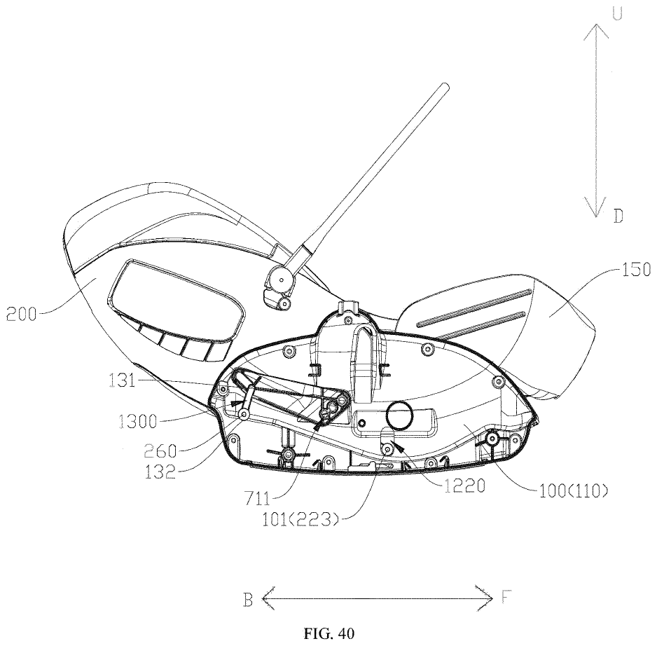

As shown in FIGS. 39 and 40, a child carrier 1000 according to a third embodiment of the present application has substantially the same configuration as that of the second embodiment, except that the back rest part 200 and the leg rest part 150 of the child carrier 1000 of the third embodiment are respectively connected to the rear and front sides of the housing 110; and the leg rest part 150 is fixedly connected to the housing 110. In this embodiment, the leg rest part 150 is fixedly connected to the housing 110 through fasteners such as screws. The back rest part 200 and the housing 110 are pivotally connected at a fixed first pivot point 101. One of the back rest part 200 and the housing 110 may has a limiting protrusion 260, and another of the back rest part 200 and the housing 110 may has a limiting groove 1300. The limiting protrusion 260 is inserted in the limiting groove 1300. When the back rest part 200 pivots relative to the housing 110, the limiting protrusion 260 slides in the limiting groove 1300, so as to guide a pivotal stroke of the back rest part 200 with respect to the housing 110 and make the pivoting more stable. Specifically, the limiting groove 1300 is an arc-shaped groove at a rear edge of the housing side plate. The limiting groove 1300 has a first end 131 and a second end 132. When a pivot angle of the back rest part 200 with respect to the housing 110 is minimal, that is, when the child carrier 1000 is suitable for the sitting posture of the child, the limiting protrusion 260 moves to the first end 131 of the limiting groove 1300, as shown in FIG. 39. When the pivot angle of the back rest part 200 with respect to the housing 110 is maximal, that is, when the child carrier 1000 is suitable for the lie-flat posture of the child, the limiting protrusion 260 moves to the second end 132 of the limiting groove 1300, as shown in FIG. 40. In this embodiment, the first end 131 is located above and in front of the second end 132. Each of the two back rest side plates 220 of the back rest part 200 has the limiting protrusion 260. The limiting grooves 1300 are respectively formed on the two housing side plates 113 of the housing 110. The limiting grooves 1300 can be slidingly fitted with the two limiting protrusions 260.

The position of the first pivot point 101 between the back rest part 200 and the housing 110 and the position of the engaging groove 711 in the third embodiment are similar to those in the second embodiment. In the third embodiment, the first pivot point 101 is located at a lower front side of the handle coupling part 102. The mounting part 710 is disposed behind the handle coupling part 102 and at an upper edge of a surface of the housing 110 facing the riding space. Specifically, the first pivot point 101 is located at a lower middle position of the housing side plate 113. The limiting protrusion 260 or the limiting groove 1300 are located at the rear part of the housing 110. In the third embodiment, a fitting hole 1220 is formed on each of the two housing side plates 113 at the first pivot point 101. The two back rest side plates 220 are respectively provided with a pivot pin 223 which can be inserted in the pivot hole 221. As such, the housing side plate 113 (or housing 110) can be pivotally connected to the back rest side plate 220 (or back rest part 200). In the third embodiment, the position of the pivot point 101 is relatively fixed, that is, the pivot pin 223 can only pivot and cannot move in the up-down direction or in the front-rear direction.

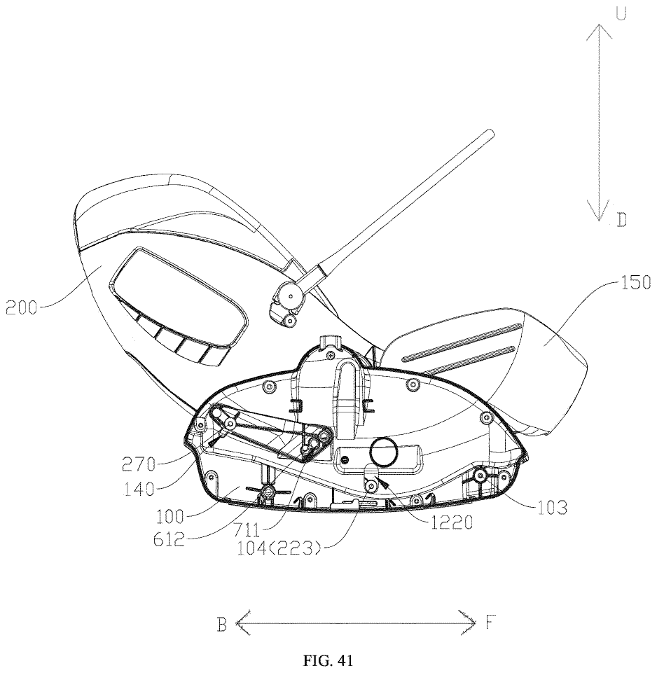

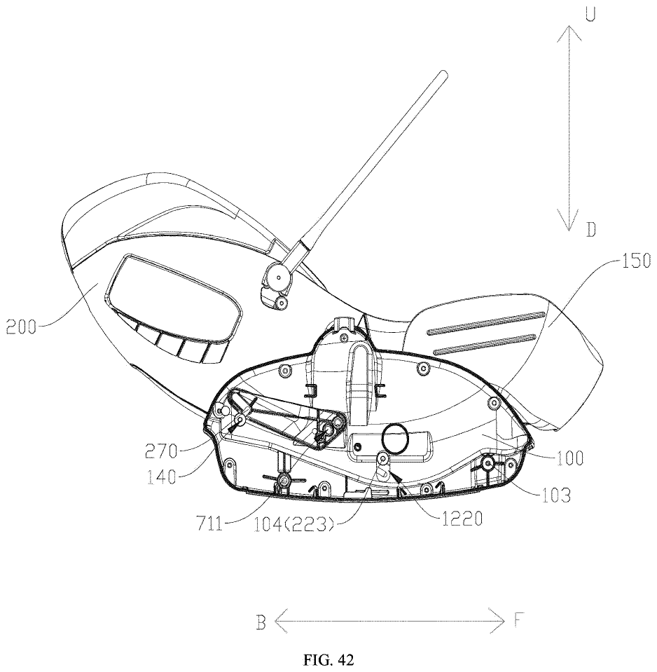

As shown in FIGS. 41 and 42, a child carrier 1000 according to a fourth embodiment of the present application has substantially the same configuration as that of the third embodiment, except that the back rest part 200 and the leg rest part 150 of the third embodiment are pivotally connected at a third pivot point 104 by a pin shaft, and the leg rest part 150 and the housing 110 are pivotally connected at the second pivot point 103. The leg rest part 150 is pivotable about the second pivot point 103 with respect to the housing 110. Specifically, one of the leg rest part 150 and the housing 110 can be provided with a rotation pin (not shown), and a rotation hole (not shown) can be formed on another of the leg rest part 150 and the housing 110. The leg rest part 150 and the housing 110 are pivotally connected at the second pivot point 103 by the rotation pin being inserted into the rotation hole. The pin shaft at the third pivot point 104 is slidable in a height direction of the housing 110. Specifically, a fitting hole 1220 is formed on the front side of each of the two housing side plates 113. The fitting hole 1220 extends in the height direction of the housing 110. Rear sides of the two back rest side plates 220 are pivotally connected to the leg rest part 150 by the two pivot pins 223, respectively. Each pivot pin 223 is inserted into the corresponding fitting hole 1220 and can move along the fitting hole 1220. As such, when the leg rest part 150 pivots relative to the housing 110, the leg rest part 150 would cause the back rest part 200 pivotally connected thereto to pivot backward, and the pivot pin 223 would slide in the height direction of the housing 110 within the fitting hole 1220. The position of the third pivot point 104 between the back rest part 200 and the leg rest part 150 and the position of the mounting part 710 in the fourth embodiment are similar to those in the second embodiment. In the fourth embodiment, the third pivot point 104 is located at the lower front side of the handle coupling part 102. The mounting part 710 is disposed behind the handle coupling part 102 and at the upper edge of the surface of the housing 110 facing the riding space.

Further, the back rest part 200 is movable relative to the housing 110. Specifically, one of the back rest part 200 and the housing 110 may be provided with a moving protrusion 270, and a moving slot 140 may be formed on another of the back rest part 200 and the housing 110. The moving protrusion 270 may be inserted into the moving slot 140 and may move along the moving slot 140. When the leg rest part 150 pivots relative to the housing 110, and the third pivot point 104 between the leg rest part 150 and the back rest part 200 moves in the height direction, the back rest part 200 moves relative to the housing 110 in the front-rear direction, and the moving protrusion 270 and the moving slot 140 can guide this movement of the back rest part 200 relative to the housing 110.

The above adjusting device and child carrier have at least the following technical effects.

The above adjusting device 600 of the child carrier selectively limits the angular position of the back rest part 200 with respect to the housing 110 by the locking mechanism 610 disposed between the housing 110 and the back rest part 200, and drives the locking mechanism 610 to switch from the locked state to the unlocked state by the operating mechanism 620. In this way, the user can adjust the angular position of the back rest part 200 by simply operating the operating mechanism 620, and other operations are not required, which is convenient to use. The different riding postures of children can be met by simply adjusting the angular position of the back rest part 200 relative to the housing 110, without involving the linkage between other components, so that the structure is simple and easy to realize.

It can be understood that, the linkage configurations of the back rest assembly and the housing in the second to fourth embodiments of the present application can also be applied to the first embodiment, and the pivot structure of the first embodiment of the present application can also be applied to the second to fourth embodiments, which is not repeatedly described in the present application.

According to the present application, the configuration of the child carrier including the adjusting mechanism or the adjusting device is simple, the angle between the seat part and the back rest part of the child carrier can be easily adjusted, and it is not prone to stuck in the adjustment, thereby improving the stability of the angle adjustment of the back rest part relative to the seat part of the child carrier.

The technical features of the embodiments described above may be combined arbitrarily. For the sake of brevity, not all possible combinations of the technical features in the embodiments are described. However, as long as there is no contradiction between the combinations of the technical features, they shall be considered as the scope of the specification.

The above-described embodiments are only some embodiments of the present application, and their description is more specific and detailed, but cannot be understood as a limitation on the scope of the application. It should be noted that, for a person of ordinary skill in the art, several modifications and improvements may be made without departing from the concept of the present application, which are within the protection scope of the present application. Therefore, the scope of protection of this patent application shall be subject to the appended claims.

1. An adjusting mechanism, configured to adjust an angle between a seat part and a back rest part, comprising:
a locking member configured to be mounted on one of the seat part and the back rest part, and having thereon a locking recess and a sliding recess; and
a detent member configured to be mounted on another of the seat part and the back rest part, and capable of moving into the locking recess or the sliding recess,
wherein when the detent member is located in the locking recess, the back rest part is fixed with respect to the seat part; and when the detent member is located in the sliding recess, the back rest part is pivotable with respect to the seat part.

2. The adjusting mechanism of claim 1, wherein the locking recess is in communication with the sliding recess, and the detent member is continuously movable between the locking recess and the sliding recess.

3. The adjusting mechanism of claim 1, wherein the locking recess comprises a first locking groove and a second locking groove, and
wherein when the detent member is located in the first locking groove, a first angle is formed between the seat part and the back rest part; and when the detent member is located in the second locking groove, a second angle, which is different from the first angle, is formed between the seat part and the back rest part.

4. The adjusting mechanism of claim 1, wherein a moving direction of the detent member is perpendicular to a transverse width direction of the seat part or the back rest part.

5. The adjusting mechanism of claim 1, further comprising:
a first operating member operatively connected to the detent member to drive the detent member to move with respect to the locking member,
wherein the first operating member is operable to move between a locked position and an unlocked position; when the first operating member is in the locked position, the detent member is located in the locking recess; and when the first operating member is in the unlocked position, the detent member is located in the sliding recess.

6. The adjusting mechanism of claim 5, further comprising:
a sliding transmission member having a connecting part and a transmission part,
wherein the detent member is fixedly connected to the connecting part, the transmission part is drivingly connected to the first operating member, and
the first operating member is configured to drive the sliding transmission member and cause the detent member to move relative to the locking member when being operated, so that the detent member is switched between the locking recess and the sliding recess.

7. The adjusting mechanism of claim 6, wherein a guide groove is formed on the transmission part; the guide groove extends in a direction intersecting with a moving direction of the first operating member; the first operating member has a drive part configured to be inserted in the guide groove and be movable along the guide groove.

8-12. (canceled)

13. A child carrier, comprising
a housing;
a back rest part pivotally connected to the housing to form a riding space for carrying a child, and having a first angular position and a second angular position relative to the housing; and
an adjusting device comprising:
a locking mechanism disposed between the housing and the back rest part, wherein the locking mechanism has a locked state in which the back rest part is fixed in the first angular position or the second angular position, and an unlocked state in which the back rest part is allowed to switch between the first angular position and the second angular position; and
an operating mechanism drivingly connected to the locking mechanism, wherein the operating mechanism is operatable to drive the locking mechanism to switch from the locked state to the unlocked state,
wherein the back rest part and the housing are pivotally connected at a fixed first pivot point, and the first pivot point is located in front of a handle coupling part disposed on the housing.

14-20. (canceled)

21. The adjusting mechanism of claim 6, wherein the locking member is mounted on the seat part, and the first operating member is movably mounted on the back rest part;
the adjusting mechanism further includes a mounting bracket configured to be fixedly mounted to the back rest part, wherein a strip-shaped sliding groove is formed on the mounting bracket; and the detent member extends through the strip-shaped sliding groove and the connecting part to be movably inserted into the locking member.

22. The adjusting mechanism of claim 3, wherein the locking recess further includes a transitional groove located between the first locking groove and the second locking groove and in communication with the sliding recess;
and when the detent member is located in the transitional groove, a third angle, which is different from the first angle and the second angle, is formed between the seat part and the back rest part.

23. A child carrier, comprising a seat part, a back rest part and an adjusting mechanism of claim 1;
wherein an end of the back rest part is pivotally connected to an end of the seat part, so that the child carrier has a first usage state and a second usage state; and the adjusting mechanism is operatively disposed between the seat part and the back rest part, so that the child carrier is capable of being switched between the first usage state and the second usage state;
wherein one of the seat part and the back rest part is provided with a first pivot fitting part, and another of the seat part and the back rest part is provided with a second pivot fitting part; and the seat part and the back rest part are pivotally connected through the first pivot fitting part and the second pivot fitting part.

24. The child carrier of claim 23, further comprising a fitting connection member, wherein the fitting connection member pivotally connects the first pivot fitting part to the second pivot fitting part.

25. The child carrier of claim 24, wherein the first pivot fitting part includes a pivot member, and the second pivot fitting part includes a pivot base; a first engagement groove is formed on the pivot base; the fitting connection member includes a pivot cover; a second engagement groove is formed on the pivot cover; the first engagement groove and the second engagement groove enclose a pivot groove; at least a part of the pivot member is inserted in the pivot groove, and rotatable in the pivot groove to switch the child carrier between the first usage state and the second usage state.

26. The child carrier of claim 23, wherein the locking recess includes a first locking groove and a second locking groove;
when the detent member is located in the first locking groove, the child carrier is in the first usage state; when the detent member is located in the second locking groove, the child carrier is in the second usage state; and when the detent member is located in the sliding recess, the back rest part is pivotable relative to the seat part, to switch the child carrier between the first usage state and the second usage state.

27. An adjusting device for a child carrier, comprising a housing and a back rest part, wherein the back rest part is pivotally connected to the housing to form a riding space for carrying a child; the back rest part has a first angular position and a second angular position relative to the housing; the adjusting device includes:
a locking mechanism disposed between the housing and the back rest part, wherein the locking mechanism has a locked state in which the back rest part is fixed in the first angular position or the second angular position, and an unlocked state in which the back rest part is allowed to switch between the first angular position and the second angular position; and
an operating mechanism drivingly connected to the locking mechanism;
wherein the operating mechanism is operable to drive the locking mechanism to switch from the locked state to the unlocked state.

28. The adjusting mechanism of claim 27, wherein the locking mechanism is movably disposed on the back rest part, and includes a locking part and a first sliding cooperative part;
the operating mechanism includes:
a second operating member; and
a linkage member connected to the second operating member and having a second sliding cooperative part;
wherein a third engaging groove and a fourth engaging groove are formed on the housing; when the locking mechanism is in the locked state, the locking part is engaged with the third engaging groove or the fourth engaging groove; and when the locking mechanism is in the unlocked state, the locking part is disengaged from the third engaging groove or the fourth engaging groove;
when the second operating member is operated, the linkage member is driven to move, and the second sliding cooperative part on the linkage member cooperates with the first sliding cooperative part on the locking mechanism, so that the locking part is disengaged from the third engaging groove or the fourth engaging groove.

29. The adjusting mechanism of claim 28, wherein the locking mechanism further includes:
an actuator having the first sliding cooperative part arranged thereon; and
a locking pin connected to the actuator, at least a part of the locking pin forming the locking part.

30. The adjusting mechanism of claim 29, wherein the actuator includes:
an actuator body; and
a positioning protrusion protruding from the actuator body and forming the first sliding cooperative part;
wherein the second sliding cooperative part is a sliding groove formed on the linkage member, and the positioning protrusion is inserted in the sliding groove and is movable along the sliding groove.

31. The adjusting mechanism of claim 30, wherein a mounting hole is formed on the actuator body; an extending direction of the mounting hole intersects with an extending direction of the positioning protrusion; and the locking pin is inserted in the mounting hole;
wherein a mounting groove, which is in communication with the mounting hole, is formed on the actuator body; an elastic finger is disposed on a side groove wall of the mounting groove; and the elastic finger cooperates with the locking pin to fix the locking pin in the mounting hole.

32. The adjusting mechanism of claim 28, wherein the operating mechanism further includes a pulling member, the linkage member includes a mounting frame movably disposed on the back rest part, wherein two ends of the pulling member are respectively connected to the second operating member and the mounting frame.
